(19) United States
(12) Patent Application Publication
(10) Pub. No.: US 2026/0206099 A1
(43) Pub. Date: Jul. 16, 2026

(54) HEATER APPARATUS

(71) Applicant: Pragmatic Semiconductor Limited, Cambridge (GB)

(72) Inventors: Adam REARDEN, Cambridge (GB); Brian COBB, Cambridge (GB); Mohsen PADASH, Cambridge (GB); Phillip ALLEN, Cambridge (GB); Richard PRICE, Cambridge (GB)

(73) Assignee: Pragmatic Semiconductor Limited, Cambridge (GB)

(21) Appl. No.: 19/558,553

(22) Filed: Mar. 6, 2026

Related U.S. Application Data
(63) Continuation of application No. PCT/GB2024/052284, filed on Sep. 3, 2024.

(30) Foreign Application Priority Data
Sep. 7, 2023 (GB) 2313687.2

(51) Int. Cl. H05B 3/14; H05B 3/00; H05B 3/26

(52) U.S. Cl. CPC H05B 3/148; H05B 3/0014; H05B 3/0019; H05B 3/26; H05B 2203/005; H05B 2203/007; H05B 2203/01

(57) ABSTRACT

Heater apparatus is disclosed. The heater apparatus includes a heating surface and heater devices arranged to provide heat for heating the heating surface. The heater devices include one or more heater field effect transistors (FETs), each having a gate, a source, and a drain. Each heater FET is arranged to generate heat for heating the heating surface when a control signal is applied to the gate of that heater FET, and a corresponding current flows between the drain and the source of that heater FET.

### RELATED APPLICATIONS

This application is a Continuation of PCT Patent Application No. PCT/GB2024/052284 filed on Sep. 3, 2024 which claims the benefit of priority of Great Britain Patent Application No. 2313687.2, filed on Sep. 7, 2023. The contents of the above applications are all incorporated by reference as if fully set forth herein in their entirety.

### FIELD AND BACKGROUND OF THE INVENTION

The present disclosure relates to heater apparatus. The present disclosure has particular, but not exclusive, relevance to small area heater devices for providing localised heating to an adjacent planar or non-planar surface.

There are many applications in which the controlled application of localised heating to heat a single site to a specific temperature, to heat different sites to different temperatures, and/or to change the temperature at a given site over time, is required or beneficial. For example, the ability to apply heat at a specific location to raise something at that location to a required temperature, and to maintain the temperature (or to adaptively control the temperature over time to match a defined temperature profile) is beneficial in many biological applications. Biological applications include, for example: cell culture applications in which a specific temperature may need to be maintained over an extended period of time for efficient replication of biological cells; polymerase chain reaction (PCR) based DNA amplification; enhancement of the detection of analytes low initial concentrations by use of temperature gradient focusing (TGF); microfluidic microbioreactor technology for microbiological cultivation; and/or the like. Other applications include chemistry (e.g., for acceleration of chemical reactions), medical and other wearables (e.g., for heating part of the body for medical or other reasons), other medical devices (e.g., for heating a medicament in an auto-injector to reduce its viscosity prior to injection), product packaging (e.g., for warming a product to-or maintaining the product at-a desired temperature), scientific and analytical instruments, and many others.

To support such applications a number of small area heater devices have been developed. These devices typically provide a planar surface that may be placed against an adjacent surface to which heat is to be applied and are available in a variety of conventional technologies.

FIG. 1 illustrates, by way of example, a configuration of a small area heater device in plan, generally at 100.

As seen in FIG. 1, the exemplary heater device configuration 100 comprises a separate heater 110 and driver integrated circuit (IC) 114.

The heater 110 employs a resistive heating element 116 comprising one or more resistive tracks formed on a flexible or rigid substrate in an appropriate pattern. In this example, the heater 110 is a discrete component that is powered by the separate driver IC 114, which typically combines control logic circuitry 118, with one or more higher current drive field effect transistors (FETs) 120, for supplying the required current to the resistive element. The driver IC 114 is generally a crystalline silicon based IC.

FIG. 2 illustrates, by way of example, a configuration of another small area heater device in cross-section, generally at 200.

As seen in FIG. 2, the exemplary heater device configuration comprises integrated heater circuitry 210 and driver (and potentially control) circuitry 214.

Specifically, in this integrated example, the heating element 216 is formed from one or more resistive tracks on the same crystalline silicon IC stack 230 that the current driver FET(s) 220 (and potentially control logic circuitry) form part of. In the illustrated example, the resistive heating element 216 is formed on an upper layer 234 of the silicon IC stack 230, whereas the driver FET(s) and any logic circuits are formed in a lower layer of the same stack 230. Connectivity between the heating element 216 and the current driver FET(s) 220 is provided by means of one or more conductive vias 236. This integration of a resistive heater element 216 and drive (and control) circuitry 214 on the same substrate provides benefits, for example in terms of cost and miniaturisation, over the heater device 100 described with reference to FIG. 1. However, while the arrangement of FIG. 2 provides a more integrated and hence compact device, the resulting device is rigid because it is formed on a crystalline silicon substrate. This reduces the versatility of the device because many applications require heat application to non-planar surfaces that a rigid device is not well suited to.

The present disclosure also provide a heater apparatus as an alternative to the heater devices described above.

Specifically, the inventors have realised that thin-film techniques can be used successfully for fabricating the driver FETs used for a heater device, as thin-film transistors (TFTs). This beneficially allows the driver FETs to be fabricated, together with a resistive heater element, at relatively low cost, on a larger variety of substrates including flexible substrates if needed.

The use of such thin-film technology is somewhat counter-intuitive because, for good performance, the heater device needs to provide a source of heat that is spatially well-controlled. For example, such heater devices are often required to provide a uniform source of heat over a defined part of the heater's surface area. However, TFTs fabricated using many thin-film technologies are known to exhibit non-uniformity (compared to crystalline silicon) over a given fabrication area (especially on certain types of substrate including flexible substrates). Moreover, TFTs typically have a relatively high on-state resistance which means that, when used as driver FETs for a resistive heating element for which a relatively high current may be needed, they can exhibit a parasitic heating effect that is seen as undesirable as it introduces an unknown element that complicates heating control. This complicates the integration of driver FET and resistive heater element on a single, e.g., flexible, substrate.

The inventors have realised, in particular, that the parasitic heating effect provided by TFTs can be comparable to—or even greater than—the heating effect provided by a conventional resistive heating element (depending on design). This has led to a heating apparatus in which the heating effect is deliberately provided, at least partially, by FETs as an alternative to, or in addition to, a conventional resistive heater element. Where the heating effect is provided by the FETs and a conventional resistive heater element together, the driver FETs used to provide current to the resistive heater element can, beneficially, provide an additional heating effect (either by themselves or together with dedicated heater FETs).

Moreover, considering that the substrate on which a TFT is fabricated is, generally, significantly less thermally conductive than crystalline silicon, the use of TFTs to provide heating allows for effective heating at a desired location with relatively little heat dissipation away from that location either through the substrate or laterally across the substrate to neighbouring locations.

It will be appreciated that while utilising the heating effect provided by TFTs allows for a particularly versatile, effective, and relatively low cost alternative to conventional heater devices, crystalline silicon based FETs can, nevertheless, be made to exhibit a similar heating effect. Accordingly, they can also be used as the basis for a similar alternative heater apparatus (e.g., if a flexible substrate is not necessary).

### SUMMARY OF THE INVENTION

In one example disclosed herein there is provided heater apparatus comprising: a heating surface; and a plurality of heater devices arranged to provide heat for heating the heating surface; wherein the plurality of heater devices comprises at least one heater field effect transistor (FET) having a gate, a source, and a drain; and wherein the at least one heater FET is arranged to generate heat for heating the heating surface when a control signal is applied to the gate of the at least one heater FET, and a corresponding current flows between the drain and the source of the at least one heater FET.

The at least one heater FET may be a thin film transistor (TFT) fabricated from a thin semiconductor film. The at least one heater FET may comprise a plurality of heater FETs, each heater FET of the plurality of heater FETs being arranged to generate heat for heating a different respective part of the heating surface. At least one heater FET of the plurality of heater FETs may be connected in electronic series with at least one other heater FET of the plurality of heater FETs.

The plurality of heater FETs may comprise a first subset of heater FETs, and at least one further subset of heater FETs. The heater FETs of the first subset may be connected in electronic series, the heater FETs of the at least one further subset may be connected in electronic series, and the first subset of heater FETs may be connected in electronic parallel with the at least one further subset of heater FETs. The heater FETs of the first subset may be arranged beneath a first region of the heating surface that extends around, and defines an external boundary of, an inner area of the heating surface beneath which no heater FETs of the plurality of heater FETs are located. The heater FETs of the at least one further subset may be arranged beneath a second region of the heating surface that extends around the first region, and a width of the inner area may be greater than a closest distance between the heater FETs of the first subset and the heater FETs of the at least one further subset.

The plurality of heater FETs may be arranged in a regularly spaced array.

The plurality of heater FETs may be provided on a common substrate. The common substrate may be a flexible substrate.

The plurality of heater devices may comprise at least one passive heater element for providing a required heating effect for heating the heating surface when a corresponding drive current flows through the at least one passive heater element. The at least one heater FET may comprise at least one heater FET arranged to generate heat for heating a different part of the heating surface than a part of the heating surface heated by the at least one passive heater element. The at least one heater FET may comprise at least one heater FET arranged to generate heat for heating part of the heating surface that the at least one passive heater element is also arranged to heat. The at least one heater FET may be arranged for providing the corresponding drive current for the at least one passive heater element. The at least one passive heater element may comprise at least one track having a resistance configured to provide the required heating effect when the corresponding drive current flows along the at least one conductive track. The at least one passive heater element may comprise at least one further FET, wherein the at least one further FET may have an interconnected gate and drain and may be configured to provide the required heating effect when the corresponding drive current flows between the drain and a source of the at least one further FET. The at least one heater FET and the at least one passive heater element may be provided as part of an integrated structure provided on a common substrate.

The at least one heater FET may be provided at a first distance from the common substrate in a direction orthogonal to the common substrate, and the at least one passive heater element may be provided at a second distance from the common substrate in a direction orthogonal to the common substrate, wherein the first and second distances are different to one another. The at least one heater FET may be provided at a first distance from the common substrate in a direction orthogonal to the common substrate, and the at least one passive heater element may be provided at a second distance from the common substrate in a direction orthogonal to the common substrate, wherein the first distance equals the second distance. At least one of the first distance and the second distance may be zero.

At least part of the at least one heater FET and at least part of the at least one passive heater element may be provided in a common layer of the integrated structure.

At least part of the at least one heater FET may be electrically connected to at least part of the at least one passive heater element by at least one conductive via provided as part of the integrated structure.

The heater apparatus may further comprise at least one thermally conductive element arranged for spreading heat between at least a subset of the plurality of heater devices.

The heater apparatus may further comprise control circuitry for providing control signals to the respective gate of each heater FET for controlling the current that flows between the drain and the source of that heater FET. The control circuitry may be configured for providing digital control signals to the respective gate of each heater FET for controlling the current that flows between the drain and the source of that heater FET. The digital control signals may comprise pulse width modulated signals having a duty cycle configured to control the power dissipated by the at least one heater FET. The control circuitry may be configured for providing analogue control signals to the respective gate of each heater FET for controlling the current that flows between the drain and the source of that heater FET.

The heater apparatus may further comprise at least one antenna for receiving wireless signals. The at least one antenna may be configured for receiving wireless signals for controlling the at least one heater FET.

The heater apparatus may further comprise energy harvesting circuitry for harvesting energy from the wireless signals for powering the at least one heater device.

In one example disclosed herein there is provided a method of manufacturing a heater apparatus according to any proceeding claim, the method comprising: fabricating the plurality of heater devices in an arrangement configured to provide heat for heating the heating surface; wherein the plurality of heater devices comprises the at least one heater field effect transistor (FET) having the gate, the source, and the drain; and wherein the at least one heater FET is arranged to generate the heat for heating the heating surface when the control signal is applied to the gate of the at least one heater FET, and the corresponding current flows between the drain and the source of the at least one heater FET.

In one example disclosed herein there is provided a method of providing heating to an object, the method comprising: arranging heater apparatus according to any proceeding claim with the heater surface positioned to provide heat to the object; and applying a control signal to the gate of the at least one heater FET, to control the corresponding current flow between the drain and the source of the at least one heater FET, and so provide a required heating effect.

### BRIEF DESCRIPTION OF THE SEVERAL VIEWS OF THE DRAWINGS

Embodiments of the present disclosure will now be described, by way of example, with reference to the accompanying drawings in which:

FIG. 1 is a simplified schematic illustration of a configuration of a small area heater device in plan-view;

FIG. 2 is a simplified schematic illustration of a configuration of a small area heater device in cross-section;

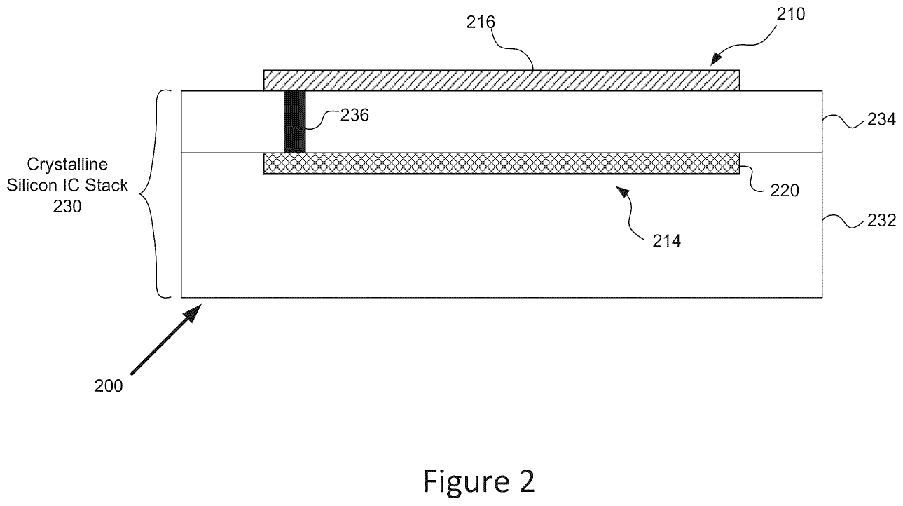

FIG. 3 is a simplified schematic illustration of a configuration of a heater device in cross-section;

FIG. 4 is a simplified cross-sectional illustration of the basic structure of a TFT that may be used as a FET in the heater apparatus shown in FIG. 3;

FIG. 5 is a simplified schematic illustration of a first exemplary implementation of heater apparatus, based on the heater apparatus shown in FIG. 3;

FIG. 6 is a simplified schematic illustration of a second exemplary implementation of heater apparatus, based on the heater apparatus shown in FIG. 3;

FIG. 7 is a simplified schematic illustration of a third exemplary implementation of heater apparatus, based on the heater apparatus shown in FIG. 3;

FIG. 8 is a simplified schematic illustration of a fourth exemplary implementation of heater apparatus, based on the heater apparatus shown in FIG. 3;

FIG. 9 is a simplified schematic illustration of a fifth exemplary implementation of heater apparatus, based on the heater apparatus shown in FIG. 3;

FIG. 10 is a simplified illustration of a cross-section of a generalised structure that may be used in the heater apparatus of FIG. 3;

FIG. 11 is a simplified illustration of a cross-section of a first more specific structure that may be used in the heater apparatus of FIG. 3;

FIG. 12 is a simplified illustration of a cross-section of a second more specific structure that may be used in the heater apparatus of FIG. 3;

FIG. 13 is a simplified illustration of a cross-section of a third specific more structure that may be used in the heater apparatus of FIG. 3;

FIG. 14 is a simplified schematic illustration of a sixth exemplary implementation of heater apparatus, based on the heater apparatus shown in FIG. 3;

FIG. 15 is a simplified schematic illustration of a seventh exemplary implementation of heater apparatus, based on the heater apparatus shown in FIG. 3;

FIG. 16 is a simplified schematic illustration of an eighth exemplary implementation of heater apparatus, based on the heater apparatus shown in FIG. 3;

FIG. 17 is a simplified schematic illustration of a ninth exemplary implementation of heater apparatus, based on the heater apparatus shown in FIG. 3;

FIG. 18 is a simplified schematic illustration of a tenth exemplary implementation of heater apparatus, based on the heater apparatus shown in FIG. 3;

FIG. 19 is is a simplified schematic of an analogue control circuit that may be used for the heater apparatus of FIG. 3; and

FIG. 20 is is a simplified schematic of a digital control circuit that may be used for the heater apparatus of FIG. 3.

### DESCRIPTION OF SPECIFIC EMBODIMENTS OF THE INVENTION

### Overview

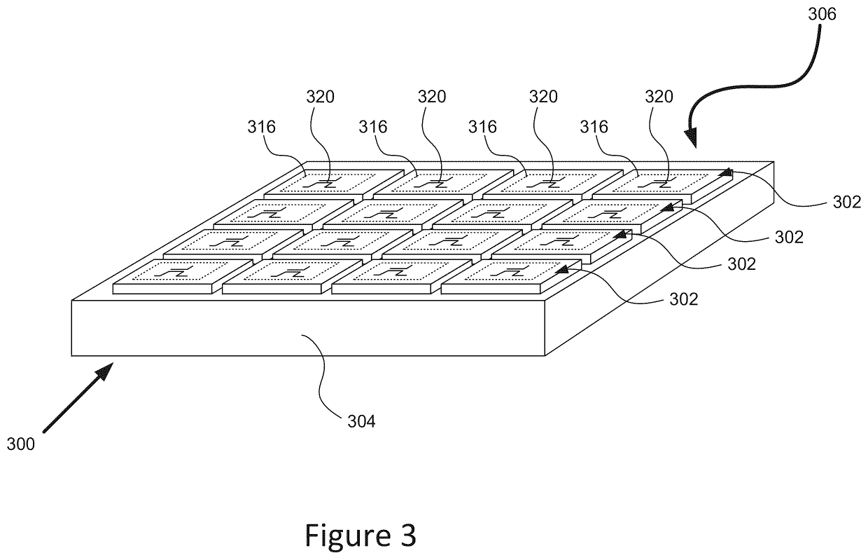

An exemplary heater apparatus will now be described in overview, by way of example only, with reference to FIG. 3, which illustrates a general configuration of a heater apparatus generally at 300. It will be appreciated that FIG. 3 is purely illustrative.

The heater apparatus 300 comprises an array of heater portions 302 arranged on (or integrated with) a substrate 304 to provide a heating surface 306 for application against, or at least near, a surface to which heating is to be applied. In the illustrated example, a four-by-four array comprising sixteen heater portions 302 providing a near continuous heating surface 306 is shown. It will, nevertheless, be appreciated that any suitable number of heater portions 302 may be provided, in any suitable regular or irregular pattern, depending on the heating application for which the heater apparatus 300 is intended to be used. The substrate 304 may be formed of any suitable rigid or flexible material depending on the application for which the heater apparatus 300 is to be used.

For a flexible substrate 304 the substrate is typically formed of an appropriate flexible polymer material. Nevertheless, the flexible substrate 304 may be formed from any other materials that provide suitable electrical, chemical, and/or structural properties. The flexible substrate 304 may be formed from a single common material, may be formed from a plurality of different materials, or may be formed from a plurality of different types of the same material. The flexible substrate 304 may, for example, comprise one or more materials selected from the following list of materials: flexible glass, polymer materials, metal oxide materials, resin materials, resist materials, foil materials, paper, insulator coated metals, or any other suitable material.

Where a polymer based material is used, the substrate 304 may comprise one or more polymers selected from: polyethylene naphthalates, polyethylene terephthalates; polymethyl methacrylates; polycarbonates, polyvinyl alcohols, polyvinyl acetates, polyvinyl pyrrolidones, polyvinyl phenols, polyvinyl chlorides, polystyrenes, polyimides, polyamides (e.g. Nylon); poly(hydroxy ethers), polyurethanes, polycarbonates, polysulfones, parylenes, polyarylates, polyether ether ketones (PEEKs); acrylonitrile butadiene styrene (ABS), 1 Methoxy 2 propyl acetates, Benzocyclobutenes (BCB), polylactic acid (PLA), polyhydroxyalkanoates (PHAs), polybutylene succinate (PBS), polybutylene adipate terephthalate (PBAT), cellulose polymers, or any other suitable polymer material.

Where a metal oxide based material is used, the substrate 304 may comprise one or more metal oxides selected from: Al₂O₃, SiOₓN_{y}, SiO₂, Si₃N₄, or any other suitable metal oxide. Where a resin based material is used, the substrate 304 may comprise one or more resins selected from: a UV-curable resin or any other suitable resin. Where a resist based material is used, the substrate 304 may comprise one or more resists selected from: nanoimprint resists, photoresists such as, for example, Bisphenol A novolac epoxy (SU-8) or polyhydroxybenzyl silsesquioxane, or any other suitable resist. Where a foil based material is used the substrate 304 may comprise one or more foils selected from: polymeric foils or any other suitable foil. Where an insulator-coated metal is used, the substrate 304 may comprise one or more insulator-coated metals selected from: insulator coated stainless-steel or any other suitable insulator-coated metal.

As seen in FIG. 3, each of the heater portions 302 respectively comprises one or more ‘heater’ field effect transistors (FETs) 320. Each heater FET 320 is an actively controlled FET (i.e., controlled by applying an appropriate voltage to its gate) that is respectively configured to provide a desired heating effect when that heater FET 320 is turned on and passing current through its channel. As those skilled in the art will understand, the respective power dissipated by, and hence heating effect provided by, each heater FET 320 while it is turned on will be governed by (amongst other things) the drain-to-source on-state resistance (R_{DS(on)}) of the FET's and the drain-source current flowing through the channel (squared). The drain-to-source on-state resistance is governed by a number of factors including the channel length, the type of semiconductor material used, any doping in the channel region, and the gate voltage applied (which also affects the drain-source current flowing).

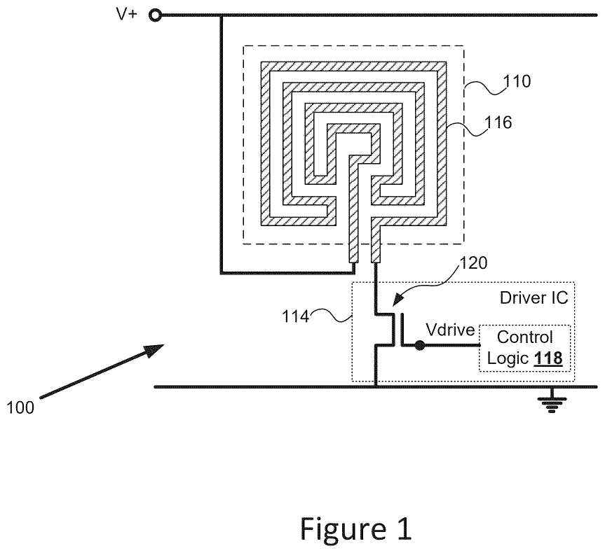

As illustrated, each heater portion 302 may also respectively comprise a resistive heater element 316 that is integrated with the corresponding heater FET(s) 320, for providing a supplemental heating effect if required. Whilst the resistive heater element 316 may comprise a resistive heater track formed of an appropriate conducting material (e.g., as shown in FIG. 1) it may, alternatively or additionally, comprise one or more diode-connected FETs (FETs with source and drain connected) which, unlike the heater FETs 320 are passively controlled, rather than actively controlled (but may be driven by current from one or more heater FET(s) 320).

As those skilled in the art will understand, the power dissipated by, and hence supplemental heating effect provided by, each resistive heater element 316 will depend on the resistivity of the material from which that track is made, the dimensions of that track (cross-sectional area, and length), and the amount of current passed through the track (squared). Beneficially, where a heater portion 302 comprises a resistive heater element 316, the heater element 316 may be driven by one (or more) of the corresponding heater FETs 320 of that heater portion 302. It will be appreciated that, in a variation on this, only a subset of one or more (but not all) heater portions 302 may have both a resistive heater element 316 and one or more heater FETs 320. In this variation another subset of one or more (but not all) heater portions 302 may have only the heater FET(s) 320.

The heater FETs 320 (and hence any resistive heater elements 316 controlled by the heater FETs 320) may be configured for combined control to allow the entire heating surface 306 to be heated simultaneously. Nevertheless, the heater FETs 320 (and hence any resistive heater elements 316 controlled by the heater FETs 320) may be configured for separate individual control, to allow different parts of the heating surface 306 (corresponding to different heater FETs 320) to be heated to different temperatures to one another—or not heated at all. Similarly, different subsets or groups of heater FETs 320 (and hence any resistive heater elements 316 controlled by the heater FETs 320) may be configured for joint control, to allow different parts of a heating surface 306 (corresponding to different groups/subsets of heater FETs 320) to be heated to different temperatures to one another—or not heated at all.

It can be seen, therefore, that the heater apparatus 300 beneficially provides spatially distributed control of temperature by using a spatial distribution of heater FETs 320. Where resistive heater elements 316 are also used and integrated with the heater FETs 320, the heater FETs 320 may beneficially be used as the drive FETs for the resistive heater elements 316. When the heater FETs 320 and resistive heater elements 316 are integrated onto a flexible substrate the heater apparatus 300 effectively forms an integrated heater-driver flexible integrated circuit (IC) that is relatively low cost and can be used in a large variety of applications.

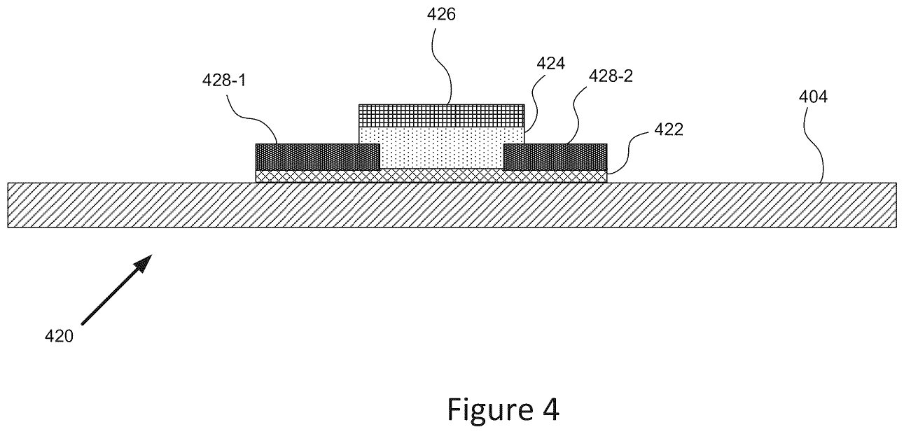

The heater FETs 320 are, in this example, thin-film transistors (TFTs) that are fabricated on to/integrated with the substrate 304. A typical TFT structure will now be described by way of example only with reference to FIG. 4, which is a simplified cross-sectional illustration of the basic structure of a TFT, generally at 420.

As seen in FIG. 4, a TFT 420 comprises a thin layer of semiconductor material 422 that, in the illustrated example, is formed on a substrate 404 (e.g., corresponding to the substrate 304 of the heater apparatus 300 of FIG. 3). It will nevertheless be appreciated that the semiconductor layer 422 may be formed on a dielectric layer formed on or in the substrate depending on the type of substrate. A gate dielectric 424 is formed on at least part of the semiconductor layer 422.

Appropriate materials for the gate dielectric may include one or more dielectrics selected from: metal oxides, metal phosphates, metal sulphates, metal sulphites, metal nitrides, metal oxynitrides, inorganic insulators, spin-on glass, polymeric dielectric materials, UV-curable resins, nanoimprint resists, photoresists or any other suitable dielectric material. For example, the gate dielectric may include one or more dielectric materials selected from: metal oxides such as Al₂O₃, ZrO₂, HfO₂, Y₂O₃, Si₃N₅, TiO₂, Ta₂O₅ or any other suitable metal oxide; metal phosphates such as Al₂POₓ or any other suitable metal phosphate; metal sulphites such as HfSOₓ or any other suitable metal sulphite; metal nitrides such as AlN, TiN, ZrN, TaN, HfN or any other suitable metal nitride; metal oxynitrides such as AlOₓN_{y} or any other suitable metal oxynitride; inorganic insulators such as SiO₂, Si₃N₄, SiNₓ or any other suitable inorganic insulator; spin on glass such as polyhydroxybenzyl silsesquioxane or any other suitable spin on glass; and/or polymeric dielectric materials such as amorphous fluoropolymers (Cytop®), Bisphenol A novolac epoxy (SU-8), benzocyclobutenes (BCB), polyimides, polymethyl methacrylates, polybutyl methacrylates, polyethyl methacrylates, polyvinyl acetates, polyvinyl pyrrolidones, polyvinyl alcohols, polyvinyl phenols, polyvinyl chlorides, polystyrenes, polyethylenes, polycarbonates, parylenes, silicone, or any other suitable polymeric dielectric materials. The dielectric material may have a relatively low dielectric constant κ (low-κ) such as Cytop®, polyhydroxybenzyl silsesquioxane, parylenes) or a relatively high dielectric constant κ (high-κ) such as Ta₂O₅, HfO₂, or any other insulating oxides, oxynitrides, silicates, etc.

A gate electrode 426 (of an appropriate conductive material) is formed on the gate dielectric such that when, in operation, a positive (or negative) voltage is applied to the electrode, electrons (or ‘holes’) are drawn to the surface of the semiconductor layer 422, beneath the gate dielectric, to form a conductive channel. This part of the semiconductor layer 422 in which the channel forms, in operation, is referred as the channel region. Source and drain electrodes 428-1 and 428-2 are formed (of an appropriate conductive material) that provide an electrical contact to the semiconductor layer at either end of the channel region. These source and drain electrodes 428-1 and 428-2 are arranged such that when the channel is present, and a potential difference is applied between the electrodes 428-1 and 428-2, current will flow between them. In the illustrated example the source and drain electrodes 428-1 and 428-2 are formed on the semiconductor layer but it will be appreciated that they could be formed directly on the substrate 404 (or a dielectric layer formed on the substrate) in contact with semiconductor layer 422 at either end of the channel region. The level of current that flows will depend on the potential difference between the source and drain electrodes 428-1 and 428-2 and the gate voltage. The gate region of the semiconductor layer may be doped appropriately to decrease or increase the free electrons in that region to make the region more p-type or n-type respectively. Similarly the regions of the semiconductor layer beneath the electrodes 428-1 and 428-2 may be doped, in an opposite manner to the gate region, to make them more n-type or p-type respectively. Nevertheless, doping is not necessarily required (e.g., depending on the semiconductor material used).

It can be seen from this generalised example, and the more detailed examples described below, that one advantage of the heater apparatus described is the integration of heater circuitry and drive circuitry (and potentially control and/or other circuitry) as part of a single, compact, low-cost integrated circuit, such as a flexible IC. Moreover, this integration can be provided without compromising on scale (miniaturisation). The resulting integrated circuit may be thin and flexible thereby providing for an increased versatility of application and enabling additional applications for which crystalline silicon base ICs are not best suited. The techniques described have the flexibility to be applied to provide a range of different, and potentially bespoke, integrated heater IC designs for addressing particular end-use applications, digital control interfaces, etc. The heater apparatus may be configured to employ very granular spatial, and temporal, control of temperature distribution over a given area and/or time. As described in more detail later, the heater apparatus also has the potential for providing a reduction in the complexity of the control logic used for arrays of heating elements using a digital control methodology.

A number of exemplary implementations of the heater apparatus 300 will now be described in more detail.

### Laterally Offset Heater FETs and Resistive Heater Elements

It will be appreciated that in the heater apparatus 300 of FIG. 3 the heater FETs 320 and resistive heater elements 316 may be laterally offset from one another (offset in a direction generally parallel to the heating surface when flat) so that the heater FETs 320 and resistive heater elements 316 provide heating to different parts of the heating surface 306.

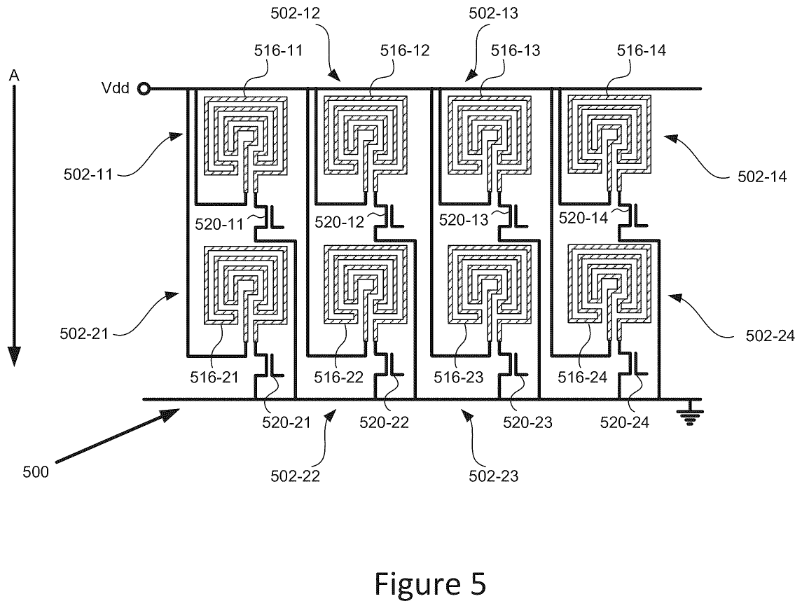

Examples of a number of lateral offset arrangements will now be described in more detail with reference to FIGS. 5 to 7.

In these examples, the heater apparatus takes the form of a plurality of (or an array of) distinct resistive heating elements, each resistive heating element being driven by its own heater FET(s) located nearby.

FIG. 5 shows a first exemplary implementation of heater apparatus, based on the heater apparatus shown in FIG. 3, in plan-view generally at 500. It will be appreciated that in FIG. 5 the corresponding heating surface would be generally parallel to the plane of the page.

As seen in FIG. 5, in this example the heater apparatus 500 comprises an array of eight heater portions 502-11 to 502-24 (e.g., corresponding to the heater portions 302 of the heater apparatus 300 of FIG. 3 and where the suffix of the reference numeral indicates the row-column position) arranged in two rows and four columns. Each heater portion 502-11 to 502-24 respectively comprises a heater FET 520-11 to 520-24 and a resistive heater element 516-11 to 516-24.

Whilst FIG. 5 is schematic, it shows the general positioning of the heater FETs 520-11 to 520-24 relative to the corresponding resistive heater elements 516-11 to 516-24. In this example, each heater FET 520-11 to 520-24 is laterally offset from the corresponding resistive heater element 516-11 to 516-24, in the same direction (the direction of Arrow A in FIG. 5, generally perpendicular to the row of heater portions 502-11 to 502-14). It can be seen that, in this arrangement, the first row of heater FETs 520-11 to 520-14 are positioned laterally between the corresponding first row of resistive heater elements 516-11 to 516-14 and the second row of resistive heater elements 516-21 to 516-24. Moreover, in this arrangement, the resistive heater elements 516-11 to 516-24 of each column of heater portions 502-11 to 502-24 are positioned adjacent to one another (in a direction perpendicular to arrow A, generally parallel to the heating surface when flat). Similarly, the heater FETs 520-11 to 520-24 of each column of heater portions 502-11 to 502-24 are positioned generally adjacent to one another.

In this example, each heater FET 520-11 to 520-24 is arranged to provide drive current to the respective resistive heater element 516-11 to 516-24. It will be appreciated that for each heater FET 520-11 to 520-24 shown in FIG. 5 there may be a plurality of heater FETs. Where there are a plurality of heater FETs for each heater portion 502-11 to 502-24, one or more of those heater FETs may be arranged to provide heating, but not drive current to the corresponding resistive heater element 516-11 to 516-24.

It will be appreciated that control logic for controlling the heater FETs 520-11 to 520-24 may be integrated with the heater apparatus 500 or provided separately.

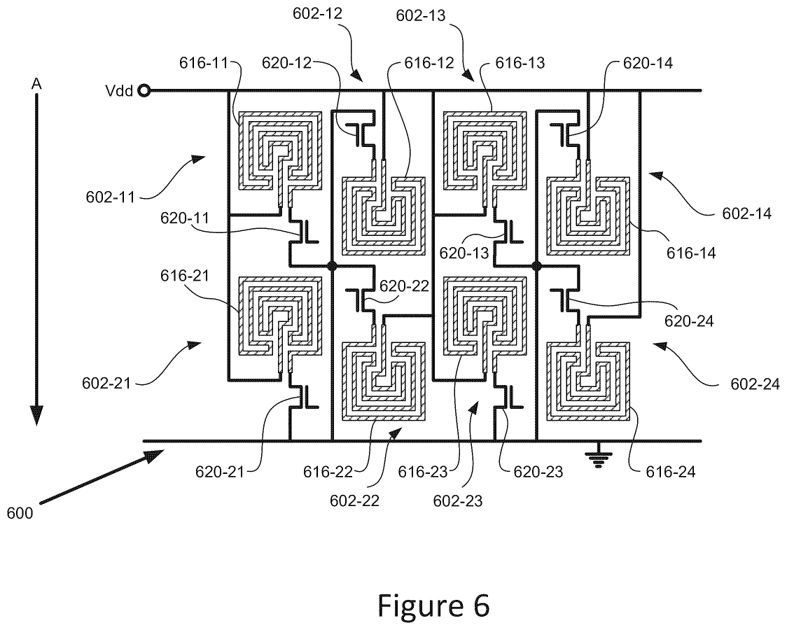

FIG. 6 shows a second exemplary implementation of heater apparatus, based on the heater apparatus shown in FIG. 3, in plan-view generally at 600. It will be appreciated that in FIG. 6 the corresponding heating surface would be generally parallel to the plane of the page.

As seen in FIG. 6, in this example the heater apparatus 600 comprises an array of eight heater portions 602-11 to 602-24 (e.g., corresponding to the heater portions 302 of the heater apparatus 300 of FIG. 3 and where the suffix of the reference numeral indicates the row-column position) arranged in two rows and four columns. Each heater portion 602-11 to 602-24 respectively comprises a heater FET 620-11 to 620-24 and a resistive heater element 616-11 to 616-24.

Whilst FIG. 6 is schematic, it shows the general positioning of the heater FETs 620-11 to 620-24 relative to the corresponding resistive heater elements 616-11 to 616-24. As in the example of FIG. 5, in this example, the heater FETs 620-11 to 620-24 and corresponding resistive heater elements 616-11 to 616-24 are laterally offset from one another (in the direction of Arrow A in FIG. 6, generally perpendicular to the row of heater portions 602-11 to 602-14). However, in this example, heater portions 602-11 to 602-24 in each row have an opposite orientation (representing a 180° rotation) relative to adjacent heater portions 602-11 to 602-24 in the same row. Nevertheless, heater portions 602-11 to 602-24 in each column have the same orientation as adjacent heater portions 602-11 to 602-24 in the same column.

Specifically, as seen in FIG. 6, the heater FETs 620-11, 620-13, 620-21, 620-23 of the first and third columns are laterally offset, from the corresponding resistive heater elements 616-11, 616-13, 616-21, 616-23 of that column, in a first direction. Contrastingly, the heater FETs 620-12, 620-14, 620-22, 620-24 of the second and fourth columns are laterally offset, from the corresponding resistive heater elements 616-12, 616-14, 616-22, 616-24 of that column, in a second direction that is opposite to the first direction.

As in FIG. 5, in this example, each heater FET 620-11 to 620-24 is arranged to provide drive current to the respective resistive heater element 616-11 to 616-24. It will be appreciated that for each heater FET 620-11 to 620-24 shown in FIG. 6 there may be a plurality of heater FETs. Where there are a plurality of heater FETs for each heater portion 602-11 to 602-24, one or more of those heater FETs may be arranged to provide heating, but not drive current to the corresponding resistive heater element 616-11 to 616-24.

It will be appreciated that control logic for controlling the heater FETs 620-11 to 620-24 may be integrated with the heater apparatus 600 or provided separately.

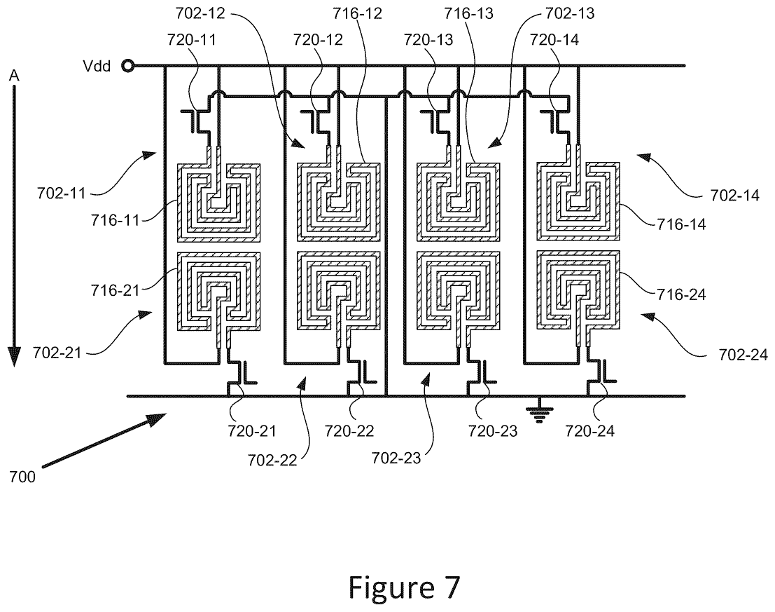

FIG. 7 shows a third exemplary implementation of heater apparatus, based on the heater apparatus shown in FIG. 3, in plan-view generally at 700. It will be appreciated that in FIG. 7 the corresponding heating surface would be generally parallel to the plane of the page.

As seen in FIG. 7, in this example the heater apparatus 700 comprises an array of eight heater portions 702-11 to 702-24 (where the suffix of the reference numeral indicates the row-column position) arranged in two rows and four columns. Each heater portion 702-11 to 702-24 respectively comprises a heater FET 720-11 to 720-24 and a resistive heater element 716-11 to 716-24.

Whilst FIG. 7 is schematic, it shows the general positioning of the heater FETs 720-11 to 720-24 relative to the corresponding resistive heater elements 716-11 to 716-24. As in the examples of FIGS. 5 and 6, in this example, the heater FETs 720-11 to 720-24 and corresponding resistive heater elements 716-11 to 716-24 are laterally offset from one another (in the direction of Arrow A in FIG. 7, generally perpendicular to the row of heater portions 702-11 to 702-14). However, in this example, heater portions 702-11 to 702-24 in each column have an opposite orientation (representing a 180° rotation) relative to adjacent heater portions 702-11 to 702-24 in the same column. Nevertheless, heater portions 702-11 to 702-24 in each row have the same orientation as adjacent heater portions 702-11 to 702-24 in the same row.

Specifically, as seen in FIG. 7, the heater FETs 720-11 to 720-14 of the first row are laterally offset, from the corresponding resistive heater elements 716-11 to 716-14 of that row, in a first direction. Contrastingly, the heater FETs 720-21 to 720-24 of the second row are laterally offset, from the corresponding resistive heater elements 716-21 to 716-24 of that row, in a second direction that is opposite to the first direction. In the illustrated arrangement the resistive heater elements 716-11 to 716-14 of the first row are adjacent the respective resistive heater elements 716-21 to 716-24 of the second row. Nevertheless, it will be appreciated that in a similar arrangement the heater FETs 720-11 to 720-14 of the first row may be positioned adjacent the respective resistive heater FETs 720-21 to 720-24 of the second row.

As in FIG. 5, in this example, each heater FET 720-11 to 720-24 is arranged to provide drive current to the respective resistive heater element 716-11 to 716-24. It will be appreciated that for each heater FET 720-11 to 720-24 shown in FIG. 7 there may be a plurality of heater FETs. Where there are a plurality of heater FETs for each heater portion 702-11 to 702-24, one or more of those heater FETs may be arranged to provide heating, but not drive current to the corresponding resistive heater element 716-11 to 716-24.

It will be appreciated that control logic for controlling the heater FETs 720-11 to 720-24 may be integrated with the heater apparatus 700 or provided separately.

### Heater FET(s) Vertically Offset From a Resistive Heater Element

It will be appreciated that in the heater apparatus 300 of FIG. 3 the heater FETs 320 and resistive heater elements 316 may be vertically offset from one another (offset in a direction generally parallel to the heating surface when flat) so that the heater FETs 320 and resistive heater elements 316 provide heating to the same parts of the heating surface 306. Moreover, a respective plurality of heater FETs 320 may be provided for each resistive heating element 316.

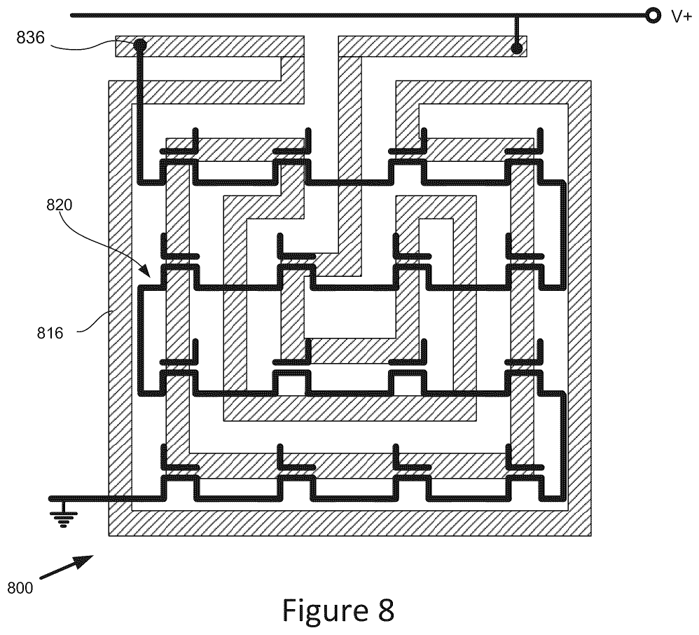

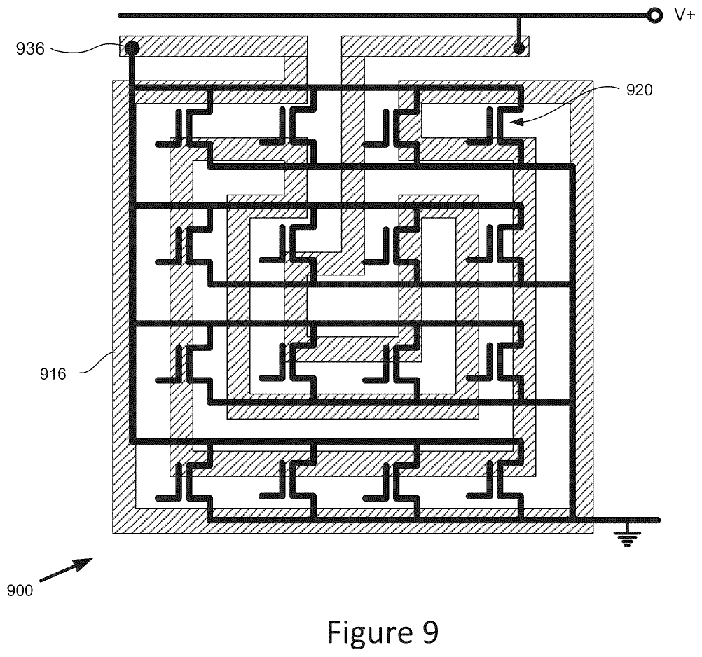

Examples of a number of vertically offset arrangements will now be described in more detail with reference to FIGS. 8 and 9.

In these examples a plurality of heater FETs provide drive for a single resistive heater element. The heater FETs are distributed over an area (generally parallel to the heating surface) that is wholly within the external boundaries of, but is vertically offset from, an area over which the corresponding resistive heater element is provided.

FIG. 8 shows a fourth exemplary implementation of heater apparatus, based on the heater apparatus shown in FIG. 3, in plan-view generally at 800. It will be appreciated that in FIG. 8 the corresponding heating surface would be generally parallel to the plane of the page.

As seen in FIG. 8, the heater apparatus 800 comprises a plurality of heater FETs 820 that are connected in series and are arranged to provide drive current to a single resistive heater element 816. Whilst FIG. 8 is schematic, it shows the general positioning of the heater FETs 820 relative to the corresponding resistive heater element 816.

In this example the heater apparatus 800 comprises sixteen heater FETs 820 arranged in four rows and four columns each having four heater FETs 820, and extending over an area that is wholly within the external boundaries of the resistive heater element 816. The heater FETs 820 are integrated into a layer of the heater apparatus structure that is vertically offset from the resistive heater element 816 (e.g., separated by a dielectric layer of an appropriate thickness except where an electrical connection between the layers is required). Drive connectivity from the heater FETs 820 to the resistive heater element 816 may be provided by a conductive via 836 of an appropriate material.

FIG. 9 shows a fifth exemplary implementation of heater apparatus, based on the heater apparatus shown in FIG. 3, in plan-view generally at 900. It will be appreciated that in FIG. 9 the corresponding heating surface would be generally parallel to the plane of the page.

As seen in FIG. 9, the heater apparatus 900 comprises a plurality of heater FETs 820 that are connected in parallel and are arranged to provide drive current to a single resistive heater element 916. Whilst FIG. 9 is schematic, it shows the general positioning of the heater FETs 920 relative to the corresponding resistive heater element 916.

In this example the heater apparatus 900 comprises sixteen heater FETs 920 arranged in four rows and four columns each having four heater FETs 920, and extending over an area that is wholly within the external boundaries of the resistive heater element 916. The heater FETs 920 are integrated into a layer of the heater apparatus structure that is vertically offset from the resistive heater element 916 (e.g., separated by a dielectric layer of an appropriate thickness except where an electrical connection between the layers is required). Drive connectivity from the heater FETs 920 to the resistive heater element 916 may be provided by a conductive via 936 of an appropriate material.

Moreover, the heater FETs 920 may be arranged in any suitable pattern (e.g., depending on the application for which the heater apparatus 900 is to be used).

While the examples of FIGS. 8 and 9 each show a single continuous resistive heater element there may be a plurality of resistive heater elements arranged in any suitable pattern depending on the application for which the heater apparatus is to be used (e.g., in an array of heater portions similar to those illustrated in FIGS. 3 and 5 to 7). Moreover, while sixteen heater FETs are shown in this example there may respectively be any suitable number (including a single heater FET) for each resistive heater element (e.g., depending on the relative sizes of the resistive heater element and the heater FET(s)).

Moreover, while the respective area covered by the heater FETs in each of the examples of FIGS. 8 and 9 is shown to be wholly within the boundaries of the corresponding resistive heater element, the area covered by the heater FET(s) may be only partially aligned with (i.e., only partially overlapping) that of the corresponding resistive heater element.

### Heater Apparatus Structure

In the examples of FIGS. 8 and 9 the heater apparatus has a structure in which the heater FETs are formed in one or more layers that are distinct from the layer in/on which the resistive heater element is formed. For example, the heater FETs may be fabricated in one or more layers that lie beneath (when the heating surface is uppermost) the layer(s) in/on which the resistive (heater) element is located. Alternatively, the heater FETs may be fabricated in one or more layers that lie above (when the heating surface is uppermost) the layer(s) in/on which the resistive (heater) element is located. In such cases, the drive current is provided to the resistive element through one or more conductive vias between the resistive heater element and the respective heater FET layer(s). It will be appreciated that a similar structure could also be used in the examples of FIGS. 5 to 7 albeit, in those examples, each heater FET and its corresponding resistive heater element are laterally offset from one another.

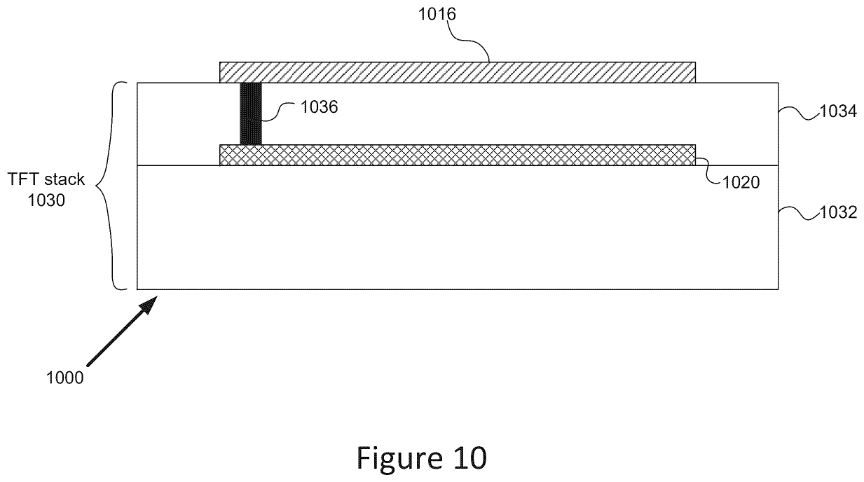

A number of possible structures for the heater apparatus will now be described, by way of example only, with reference to FIGS. 10 to 13.

FIG. 10 shows, in simplified form, a generalised cross-section of one such structure that may be used in the heater apparatus of FIG. 3, for example when implemented in accordance with the examples of FIG. 8 or 9, generally at 1000. It will nevertheless be appreciated that the structure 1000 may be adapted to be used in accordance with the examples of FIGS. 5 to 7.

As seen in FIG. 10, one or more heater FETs 1020 (in this example TFTs) are formed on/in one or more lower layers 1032. The FET(s) 1020 are covered by one or more upper layers 1034 (typically formed of an appropriate dielectric material). One or more resistive heater elements 1016 are formed on/in the upper layer(s) 1034. In these examples the lower layer(s) comprise an appropriate substrate for the TFT(s). Connectivity between the resistive heating element(s) 1016 and the heater FET(s) 1020 is provided by means of one or more conductive vias 1036.

It will be appreciated that FIG. 10 is simplified and, in a real implementation, some component parts (e.g., gate electrodes) of the heater FET(s) 1020 may be formed in the same layer as the resistive heater element(s) 1016. Similarly, the resistive heater element(s) may comprise features of conductive tracking in the same layer(s) as at least part of the heater FET(s) (e.g., the same layer as the gate, source, and/or drain electrodes. Moreover, the resistive heater element(s) may comprise features of the material from which they are made in the same layer(s) as the driver FET channel (e.g., where one or more of the resistive elements is a diode-connected FETs).

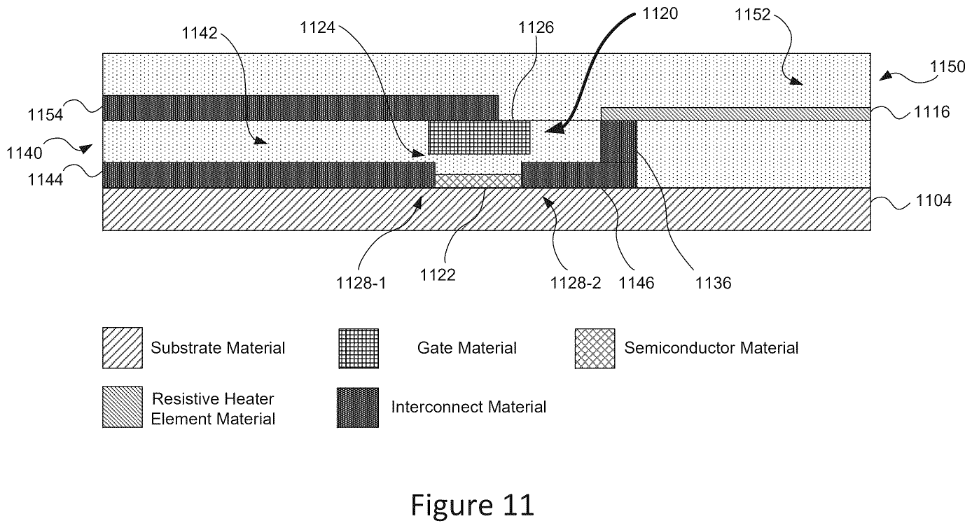

FIG. 11 shows, in simplified form, a more detailed cross-section of a first structure that may be used in the heater apparatus of FIG. 3, in particular when implemented in accordance with one of the examples of FIGS. 5 to 7.

As seen in FIG. 11, a heater FET 1120 in the form of a TFT is formed in a first layer 1140 formed on an appropriate substrate 1104. Semiconductor material is provided on the substrate 1104, which forms a channel region 1122 of the TFT. It will be appreciated that the semiconductor material may not be provided directly on the substrate 1104 but may, instead, be provided on a barrier layer, where the barrier layer is provided on the substrate 1104 (or possibly on an arrangement of one or more further layers provided on the substrate 1104). Source and drain electrodes 1128-1 and 1128-2 are formed (of an appropriate conductive material) to provide an electrical contact to (and which may overlap with) the semiconductor layer at either end of the channel region 1122. In the illustration an interconnect 1144 (formed of the same conductive material as the source and drain electrodes 1128-1 and 1128-2) is shown as a lateral extension of the source electrode 1128-1 (e.g., to provide an external connection). A first dielectric sub-layer 1142 substantially covers the source and drain electrodes 1128-1 and 1128-2 and the channel region 1122 for providing appropriate electrical insulation where needed. A gate electrode 1126 (of an appropriate conductive material) is formed in the dielectric sub-layer 1142 such that the portion of the dielectric sub-layer 1142 between the gate electrode 1126 and the channel region 1122 (the gate dielectric 1124) is of a required thickness. A conductive via 1136 is also provided that extends through the dielectric sub-layer 1142, from an interconnect 1146 formed as an extension to the drain electrode 1128-2 to provide for an electrical connection to the drain electrode 1128-2 through the first layer 1140.

A second layer 1150 is formed on the first layer 1140. The second layer 1150 comprises the material of the resistive heater element 1116 formed on the first layer in connection with the via 1136. In this example, the resistive heater element 1116 is laterally offset from the TFT 1120. The second layer 1150 also comprises an interconnect 1154, formed of the conductive material, that extends laterally away from, and electrically connected to the gate electrode (e.g., to provide an external connection). A second dielectric sub-layer 1152 substantially covers the gate interconnect 1154, gate electrode 1126, and resistive heater element 1116 for providing appropriate electrical insulation where needed.

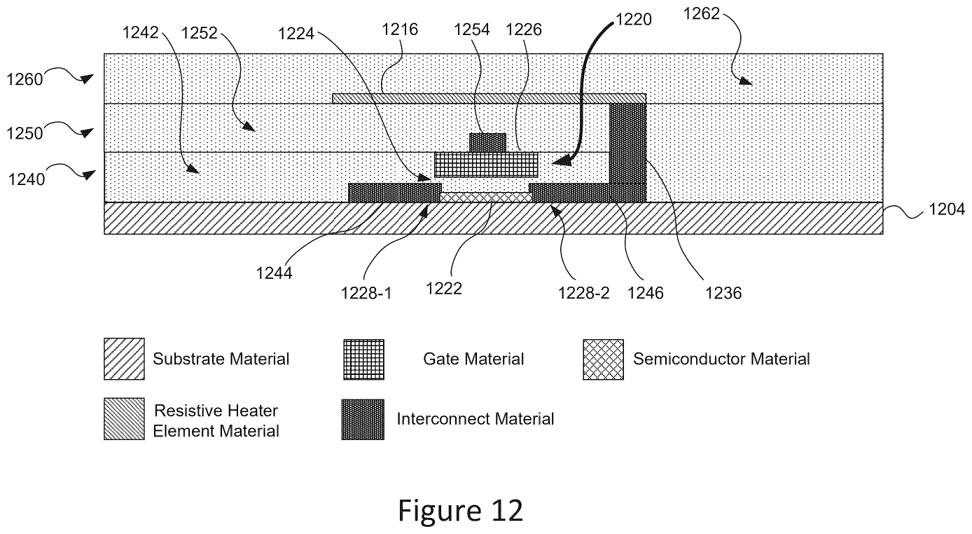

FIG. 12 shows, in simplified form, a more detailed cross-section of a second structure that may be used in the heater apparatus of FIG. 3, in particular when implemented in accordance with one of the examples of FIGS. 8 to 9.

As seen in FIG. 12, a heater FET 1220 in the form of a TFT is formed in a first layer 1240 formed on an appropriate substrate 1204. Semiconductor material is provided on the substrate 1204, which forms a channel region 1222 of the TFT. It will be appreciated that the semiconductor material may not be provided directly on the substrate 1204 but may, instead, be provided on a barrier layer, where the barrier layer is provided on the substrate 1204 (or possibly on an arrangement of one or more further layers provided on the substrate 1204). Source and drain electrodes 1228-1 and 1228-2 are formed (of an appropriate conductive material) that provide an electrical contact to (and which may overlap with) the semiconductor layer at either end of the channel region 1222. It will be appreciated that, as with the example in FIG. 11, the source electrode 1228-1 may be externally connected via an interconnect 1244 formed as an extension to the source electrode 1228-1 (the extent of which cannot be seen in the figure e.g., because it extends in a direction orthogonal to the cross-section). A first dielectric sub-layer 1242 substantially covers the source and drain electrodes 1228-1 and 1228-2 and the channel region 1222 for providing appropriate electrical insulation where needed. A gate electrode 1226 (of an appropriate conductive material) is formed in the dielectric sub-layer 1242 such that the portion of the dielectric sub-layer 1242 between the gate electrode 1226 and the channel region 1222 (the gate dielectric 1224) is of a required thickness.

A second layer 1250 is formed on the first layer 1240. The second layer 1250 comprises an interconnect 1254 formed of the conductive material electrically connected to the gate electrode 1226 to provide an external connection (the extent of which cannot be seen in the figure e.g., because it extends in a direction orthogonal to the cross-section). A second dielectric sub-layer 1252 substantially covers the gate interconnect 1254 and gate electrode 1226 for providing appropriate electrical insulation where needed.

A conductive via 1236 is also provided that extends through the dielectric sub-layers 1242 and 1252 of the first and second layers 1240 and 1250, from an interconnect 1246 to the drain electrode 1228-2 to provide for an electrical connection to the drain electrode 1228-2 through the first and second layers 1240 and 1250.

A third layer 1260 is formed on the second layer 1250. The third layer 1260 comprises the material of the resistive heater element 1216 formed on the second layer in connection with the via 1236. In this example, the resistive heater element 1216 is laterally aligned with, but vertically offset from, the TFT 1220. A third dielectric sub-layer 1262 substantially covers resistive heater element 1216 for providing appropriate electrical insulation where needed.

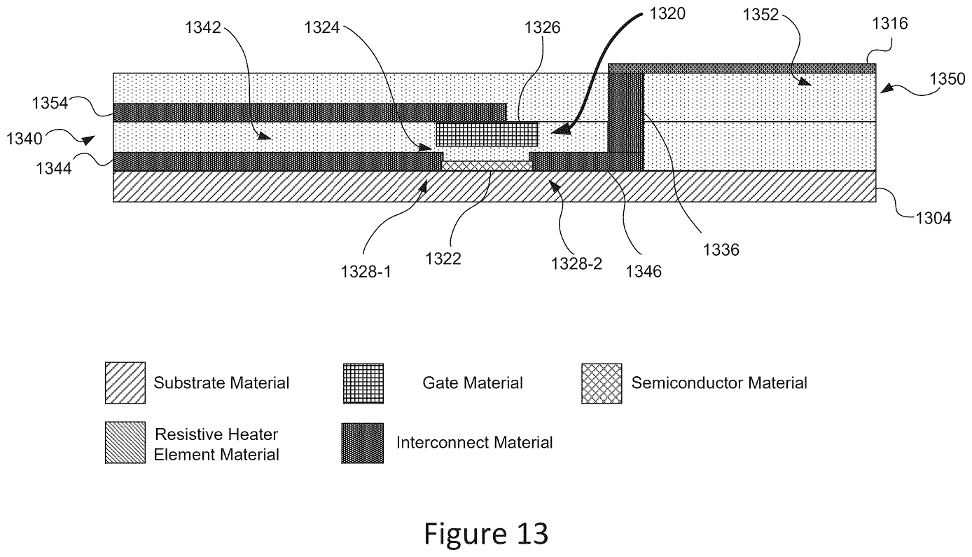

FIG. 13 shows, in simplified form, a more detailed cross-section of a third structure that may be used in the heater apparatus of FIG. 3, in particular when implemented in accordance with one of the examples of FIGS. 5 to 7.

As seen in FIG. 13, a heater FET 1320 in the form of a TFT is formed in a first layer 1340 formed on an appropriate substrate 1304. Semiconductor material is provided on the substrate 1304, which forms a channel region 1322 of the TFT. It will be appreciated that the semiconductor material may not be provided directly on the substrate 1304 but may, instead, be provided on a barrier layer, where the barrier layer is provided on the substrate 1304 (or possibly on an arrangement of one or more further layers provided on the substrate 1304). Source and drain electrodes 1328-1 and 1328-2 are formed (of an appropriate conductive material) to provide an electrical contact to (and which may overlap with) the semiconductor layer at either end of the channel region 1322. In the illustration an interconnect 1344 (formed of the same conductive material as the source and drain electrodes 1328-1 and 1328-2) is shown as a lateral extension of the source electrode 1328-1 (e.g., to provide an external connection). A first dielectric sub-layer 1342 substantially covers the source and drain electrodes 1328-1 and 1328-2 and the channel region 1322 for providing appropriate electrical insulation where needed. A gate electrode 1326 (of an appropriate conductive material) is formed in the dielectric sub-layer 1342 such that the portion of the dielectric sub-layer 1342 between the gate electrode 1326 and the channel region 1322 (the gate dielectric 1324) is of a required thickness.

A second layer 1350 is formed on the first layer 1340. The second layer 1350 also comprises an interconnect 1354, formed of a suitable conductive material, that extends laterally away from, and is electrically connected to, the gate electrode (e.g., to provide an external connection). A second dielectric sub-layer 1352 substantially covers the gate interconnect 1354 and the gate electrode 1326 for providing appropriate electrical insulation where needed. A conductive via 1336 is also provided that extends through the dielectric sub-layers 1342 and 1352 of the first and second layers 1340 and 1350, from an interconnect 1346 formed as an extension to the drain electrode 1328-2 through the first and second layers 1340 and 1350.

The resistive heater element 1316 is formed on the second layer in connection with the via 1336. In this example, the resistive heater element 1316 is laterally offset from the TFT 1320 and is provided on an external surface of the integrated circuit once formed.

### Heater FET(s) Without Resistive Heater Elements

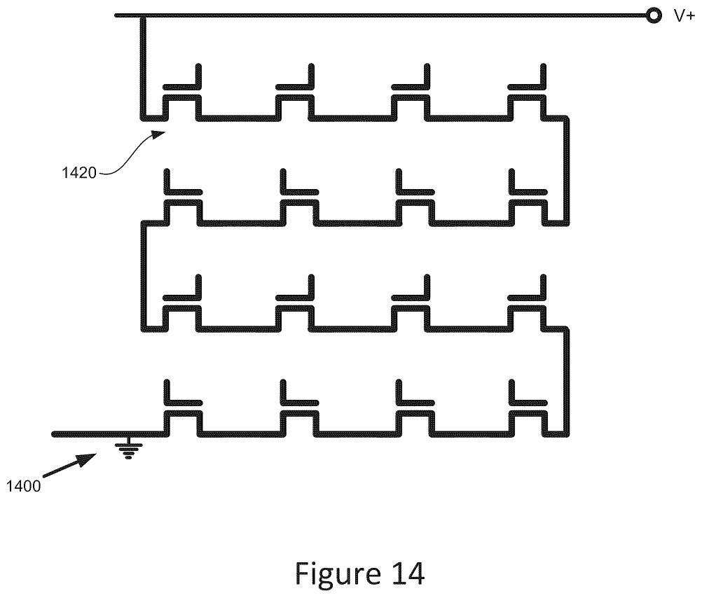

It will be appreciated that in the heater apparatus 300 of FIG. 3, the heater FETs 320 may be provided without any resistive heater elements 316. Examples of a number of such heater FET arrangements will now be described in more detail with reference to FIGS. 14 to 18.

In these arrangements, the thermally dissipative nature of FETs is exploited by using a spatial distribution of heater FETs to provide the sole (or at least dominant) source of heat. Whilst the presence of one or more additional resistive heater elements may provide benefits for some applications the use of heater FETs to provide the sole (or at least dominant) source of heat provides for a simpler and lower cost heater apparatus. It will nevertheless be appreciated that any of these arrangements of heater FETs may be used in conjunction with one or more resistive heater elements (e.g., in a manner similar to that described with reference to FIGS. 5 to 9).

It will also be appreciated that in these arrangements purely resistive (passive) heating elements may be present incidentally that contribute, albeit a relatively small amount, to the heating effect provided by the heater apparatus. For example, conductive tracking between the heater FETs may provide some heating even though their contribution to heat generation is significantly smaller than that of the heater FETs.

FIG. 14 shows a sixth exemplary implementation of heater apparatus, based on the heater apparatus shown in FIG. 3, in plan-view generally at 1400. It will be appreciated that in FIG. 14 the corresponding heating surface would be generally parallel to the plane of the page.

As seen in FIG. 14, the heater apparatus 1400 comprises a plurality of heater FETs 1420 that are connected in series. Whilst FIG. 14 is schematic, it shows the general positioning of the heater FETs 1420. In this example the heater apparatus 1400 comprises sixteen heater FETs 1420 arranged in four rows and four columns each having four heater FETs 1420 (similar to the configuration described with reference to FIG. 8 but without the resistive heater element).

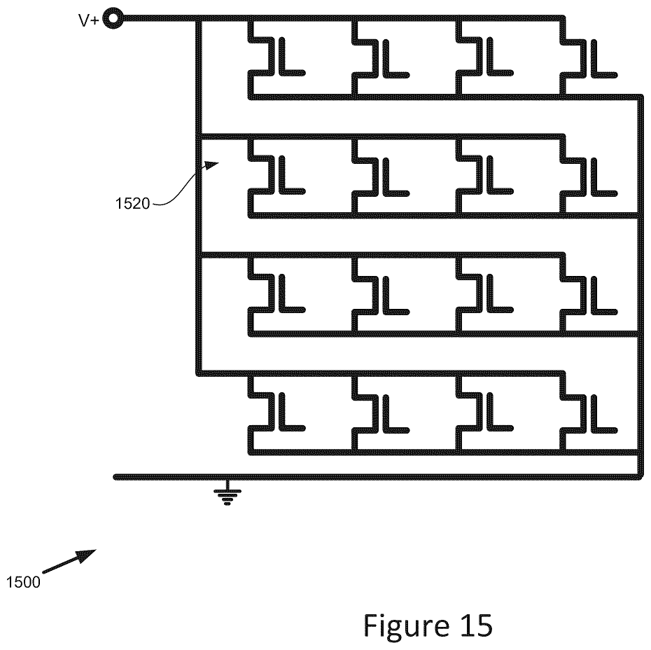

FIG. 15 shows a seventh exemplary implementation of heater apparatus, based on the heater apparatus shown in FIG. 3, in plan-view generally at 1500. It will be appreciated that in FIG. 15 the corresponding heating surface would be generally parallel to the plane of the page.

As seen in FIG. 15, the heater apparatus 1500 comprises a plurality of heater FETs 1520 that are connected in parallel. Whilst FIG. 15 is schematic, it shows the general positioning of the heater FETs 1520. In this example the heater apparatus 1500 comprises sixteen heater FETs 1520 arranged in four rows and four columns each having four heater FETs 1520 (similar to the configuration described with reference to FIG. 9 but without the resistive heater element).

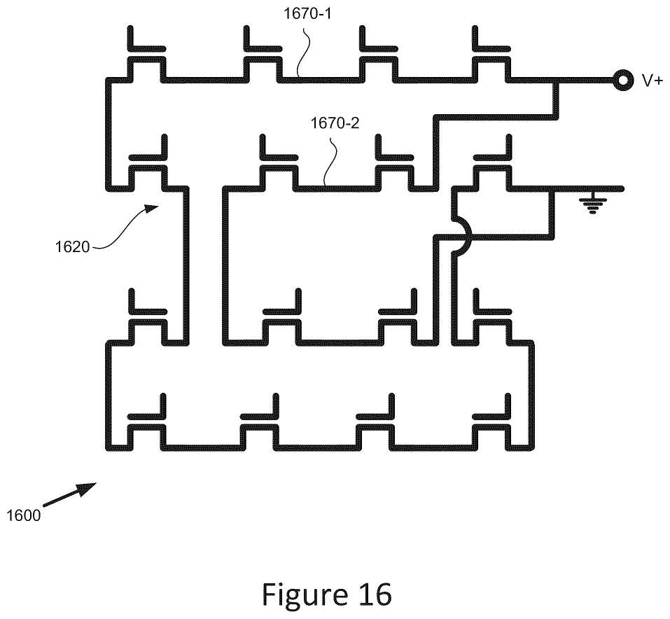

FIG. 16 shows an eighth exemplary implementation of heater apparatus, based on the heater apparatus shown in FIG. 3, in plan-view generally at 1600. It will be appreciated that in FIG. 16 the corresponding heating surface would be generally parallel to the plane of the page. Moreover, whilst FIG. 16 is schematic, it shows the general positioning of the heater FETs.

As seen in FIG. 16, the heater apparatus 1600 comprises a plurality of heater FETs 1620 that are connected in series, in a similar arrangement to that of FIG. 14, with the heater apparatus 1600 comprising sixteen heater FETs 1620 arranged in a grid of four rows and four columns each having four heater FETs 1620. In this example, however, the heater FETs 1620 comprise two parallel connected strings of series connected heater FETs 1620. In this example, each string is in the form of a generally rectangular loop 1670-1, 1670-2, with an inner loop 1670-2 comprising four heater FETs 1620 nested inside an outer loop 1670-1 comprising twelve heater FETs 1620. This arrangement allows for provision of independently controlled central and outer heating areas (i.e., by respective application of appropriately controlled gate voltages to the heater FETs 1620 of each loop 1670). Assuming identical FETs and control voltages, heat generated by the apparatus 1600 will be distributed evenly over the area of the FET grid. Nevertheless, different heating effects could be provided via the outer and inner loops 1670 if needed.

It will be appreciated that different arrangements are possible and may be beneficial in different applications, for example with non-rectangular loops, different numbers of heater FETs 1620, and/or without a nested arrangement (e.g., a plurality of parallel or interdigitated strings of heater FETs 1620 could be arranged adjacent one another).

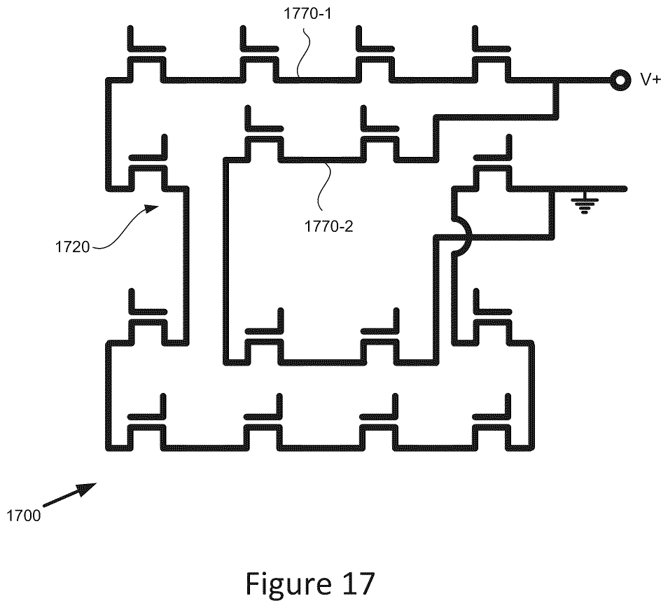

One such alternative arrangement can be seen in FIG. 17, which shows a ninth exemplary implementation of heater apparatus, based on the heater apparatus shown in FIG. 3, in plan-view generally at 1700. It will be appreciated that in FIG. 17 the corresponding heating surface would be generally parallel to the plane of the page. Moreover, whilst FIG. 17 is schematic, it shows the general positioning of the heater FETs.

As seen in FIG. 17, the heater apparatus 1700 comprises a plurality of heater FETs 1720 that are connected in series in two loops 1770-1, 1770-2, in a similar arrangement to that of FIG. 16, with the heater apparatus 1700 comprising sixteen heater FETs 1720. In this example, however, the inner loop of the heater FETs 1770-2 is enlarged compared to that of FIG. 16. This means that heat generation is weighted towards the perimeter of the heater area. Such an arrangement has the potential to help mitigate the risk of the formation of hotspots near to the centre of the heater area.

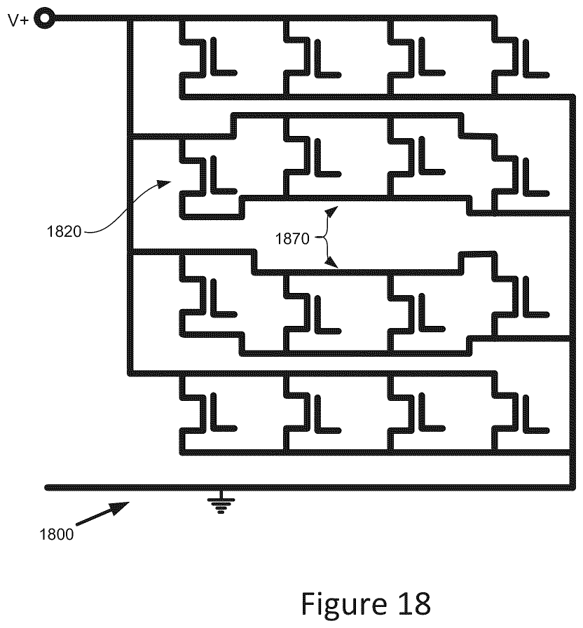

Another alternative arrangement can be seen in FIG. 18, which shows a tenth exemplary implementation of heater apparatus, based on the heater apparatus shown in FIG. 3, in plan-view generally at 1800. It will be appreciated that in FIG. 18 the corresponding heating surface would be generally parallel to the plane of the page.

As seen in FIG. 18, the heater apparatus 1800 comprises a plurality of heater FETs 1820 that are connected in parallel in a similar arrangement to that of FIG. 15, with the heater apparatus 1800 comprising sixteen heater FETs 1820. The heater FETs 1820 are arranged in an approximate grid formation with four rows and four columns each having four heater FETs 1820. In this example, however, the sixteen heater FETs 1820 are not arranged in a completely regular grid. Instead, the central two heater FETs 1870 of the second row of the grid are separated from the central two heater FETs 1870 of the third row of the grid by a greater distance than between the first (and last) heater FET of the second row and the first (and last) heater FET of the third row.

It can be seen that such an arrangement has a similar spatial distribution to that of FIG. 17 therefore has a similar potential to help mitigate the risk of the formation of hotspots near to the centre of the heater area. In this example, however, the heater FETs 1820 are all connected in parallel with one another and hence can be respectively controlled independently from one another to control/fine tune heat distribution accordingly, e.g., to provide a more uniform (or deliberately spatially varied) heat distribution.

It can be seen that, in the above heater apparatus configurations described with reference to FIGS. 3 to 9 and 14 to 18, the heater FETs may be distributed over the area to be heated in any suitable manner to achieve a required heat distribution/two-dimensional temperature profile. Whilst, in general, regularly spaced symmetric arrangements of the heater FETs have been described, the spatial distribution may be irregularly spaced and/or asymmetrically distributed. Moreover, for arrangements in which one or more resistive heater elements are present, described with reference to FIGS. 3 to 9, the arrangements of the heater FETs may be designed to provide, in combination with the one or more resistive heating elements, the required heat output distribution/two-dimensional temperature profile from the heater apparatus.

### Heater (Driver) FET Control

The heater FETs (whether operating as a driver FET for a resistive heater element or independently as a heater) may be controlled in any of a number of ways to generate a required temperature distribution depending on the application.

A number of examples of control techniques will now be described by way of example. It will be appreciated that the control techniques described may be implemented in conjunction with one or more feedback loops, for example associated with temperature sensors which are either integrated with, or external to, the heater apparatus.

### Analogue Control

Analogue control of the heater apparatus may, for example, be provided by applying a respective analogue control voltage to the gate terminals of at least some of the heater FETs. The magnitude of this control voltage will determine the on-state resistance of each heater FET during operation and hence the power and heat dissipated by it. The same control voltage may be provided for all heater FETs which, if the heater FETs are identical, will result in the same respective heat dissipation from each heater FET. Nevertheless, different respective gate voltages may be applied to different individual, or different subsets of, heater FETs to provide more granular control of the heat dissipated by the heater apparatus (i.e., with a spatial distribution that depends on the spatial distribution of control voltage).

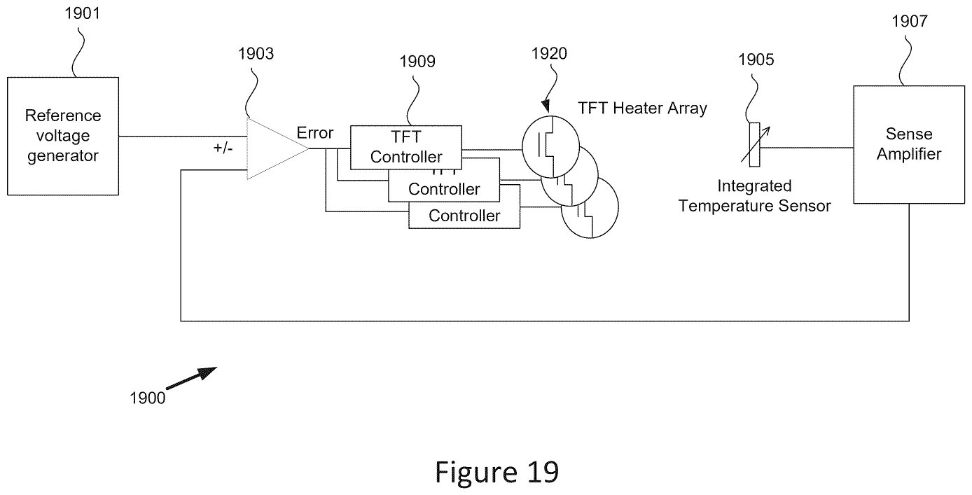

An exemplary of analogue control will now be described, by way of example only, with reference to FIG. 19, which is a simplified schematic of an analogue control circuit, shown generally at 1900, that may be used for the heater apparatus of FIG. 3.

As seen in FIG. 19, a reference voltage generator 1901 is configured to provide a reference voltage, corresponding to a desired reference temperature, as an input to a voltage comparator 1903. An integrated temperature sensor 1905 is arranged to sense the temperature produced by the heater apparatus at an appropriate location and to provide an output voltage, that corresponds to the sensed temperature. The output of the temperature sensor 1905 is provided as an input to a sense amplifier 1907 where it is amplified to provide an amplified voltage output that corresponds to the sensed temperature on a voltage-to-temperature scale that is the same as that of the reference voltage. The amplified output voltage from the sense amplifier 1907 is also provided as an input to the voltage comparator 1903.

The voltage comparator 1903 is configured to compare the respective inputs from the reference voltage generator 1901 and the sense amplifier 1907 to provide an output that depends on which of the two inputs has the largest magnitude and hence whether the actual temperature at the sensed location is higher or lower than the reference temperature. The output from the comparator is provided as an input to a respective heater controller 1909 for controlling the gate voltage applied to each heater FET 1920 of an array of heater FETs 1920. Specifically, when the temperature at the sensed location is higher than the reference temperature, the comparator 1903 provides an input to the heater controllers 1909 for controlling the respective gate voltage applied to each heater FET 1920 to stop (or reduce) the heating effect produced by that heater FET 1920. When the temperature at the sensed location is lower than the reference temperature, the comparator 1903 provides an input to the heater controllers 1909 for controlling the respective gate voltage applied to each heater FET 1920 to start (or increase) the heating effect produced by that heater FET 1920.

Hence, the heat produced by each heater FET 1920 (and any drive current provided to any passive heater element(s) by that heater FET 1920) is adjusted appropriately to increase or decrease the temperature appropriately.

It will be appreciated that whilst three heater controllers 1909 and associated heater FETs 1920 are shown, the circuit may be configured for controlling a single heater FET individually, or for controlling any suitable number of heater FETs simultaneously. The heater FET(s) controlled in this way may represent all, or a subset of, the heater FETs in any of the earlier described arrays of heater FETs.

Moreover, the control circuit 1900 may comprise a plurality of integrated temperature sensors 1905 arranged to sense the temperature at different parts of the heater surface. In this case, the control circuit 1900 may be configured for: respectively amplifying the signal from each integrated temperature sensor 1905 using one or more sense amplifiers; respectively comparing each amplified signal with a corresponding reference voltage temperature; and for respectively controlling one or more heater FETs 1920 arranged for heating the part of the heater surface sensed by the corresponding integrated temperature sensor 1905.

### Digital Control

Whilst analogue control is beneficial in certain scenarios, for some FET (and especially TFT) technologies fabrication differences can lead to a relatively high variation in the characteristics of the FETs - both across a given substrate and from batch to batch. This can make it more difficult to provide accurate control of the channel current based on the magnitude of the gate voltage, and hence lead to additional complexity in the gate drive control circuitry (e.g., to provide independent control for each gate voltage to allow differences arising from process variations to be taken into account).

Digital control of the heater apparatus has the potential to mitigate the effects of manufacturing and other sources of device characteristic variations. For example, employing one or more digital control techniques, such as pulse-width modulation (PWM), pulse density modulation or pulse frequency modulation, has the potential to provide better control of the heater FET heat dissipation in at least some scenarios. In such digital schemes, one or more (or all) of the heater FETs in the heater apparatus may be switched fully ‘on’ and ‘off’ by application of a periodic pattern of gate voltage ‘on’ pulses and ‘off’ periods (typically in the form of a square wave) that has a duty cycle (ratio of the ‘on’ time to the period of the periodic pattern) that is configured to provide the required heat dissipation. This duty cycle may also be varied over time (e.g., to provide a different heat dissipation time profile, to gradually increase/decrease the heating effect over time and/or the like). This approach may be more applicable for some applications, especially involving TFT technologies, as it can mitigate the complexities of using analogue control techniques.

It will be appreciated that the same digital control signal may be applied to all heater FETs which, if the heater FETs are identical, will result in the same respective heat dissipation from each heater FET. Nevertheless, different respective gate voltage PWM patterns may be applied to different individual, or different subsets of, heater FETs to provide more granular control of the heat dissipated by the heater apparatus (i.e., with a spatial distribution that depends on the spatial distribution of control voltage).

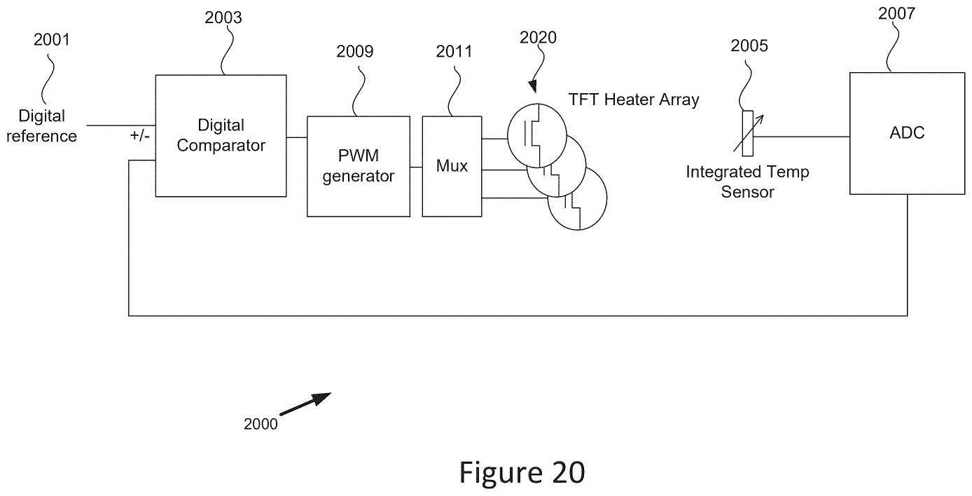

An exemplary of digital control will now be described, by way of example only, with reference to FIG. 20, which is a simplified schematic of a digital control circuit, shown generally at 2000, that may be used for the heater apparatus of FIG. 3.

As seen in FIG. 20, a digital reference signal 2001 corresponding to a desired reference temperature, provides an input to a digital comparator 2003. An integrated temperature sensor 2005 is arranged to sense the temperature produced by the heater apparatus at an appropriate location and to provide an output voltage, that corresponds to the sensed temperature. The output of the temperature sensor 2005 is provided as an input to an analogue-to-digital convertor (ADC) 2007 where it is converted to a digital output that corresponds to the sensed temperature (using the same temperature-to-voltage encoding as that of the digital reference signal). The digital output signal from the ADC 2007 is also provided as an input to the digital comparator 2003.

The digital comparator 2003 is configured to compare the digital reference signal 2001 and the digital signal from the ADC 2007 and to provide an output that depends on which of the two inputs has the largest magnitude and hence whether the actual temperature at the sensed location is higher or lower than the reference temperature. The output from the comparator is provided as an input to a pulse width modulation (PWM) generator 2009 for generating a PWM signal for respective application to the gate of each heater FET 2020 of an array of heater FETs 2020. Specifically, when the temperature at the sensed location is higher than the reference temperature, the comparator 2003 provides an input to the PWM generator 2009 for generating a PWM signal for respective application to the gate of each heater FET 2020 for stopping (or reducing) the heating effect produced by that heater FET 2020. When the temperature at the sensed location is lower than the reference temperature, the comparator 2003 provides an input to the PWM generator 2009 for generating a PWM signal for respective application to the gate of each heater FET 2020 for starting (or increasing) the heating effect produced by that heater FET 2020. The PWM signal generated by the PWM generator is switched to each heater FET 2020 in turn via an appropriate multiplexer 2011.

It will be appreciated that whilst three heater controllers 2009 and associated heater FETs 2020 are shown, the circuit may be configured for controlling a single heater FET individually, or for controlling any suitable number of heater FETs simultaneously. The heater FET(s) controlled in this way may represent all, or a subset of, the heater FETs in any of the earlier described arrays of heater FETs.

Moreover, the control circuit 2000 may comprise a plurality of integrated temperature sensors 2005 arranged to sense the temperature at different parts of the heater surface. In this case, the control circuit 2000 may be configured for: respectively converting the signal from each integrated temperature sensor 2005 using one or more ADCs 2007; respectively comparing each amplified signal with a corresponding digital reference signal; and for respectively controlling one or more heater FETs 2020 arranged for heating the part of the heater surface sensed by the corresponding integrated temperature sensor 2005.

This digital design has advantages in terms of scalability (in the number of FETs that can be driven and sensors that can be read simultaneously), reference stability, and the ability to account for variability in performance across FETs in the array.

Regardless of whether an analogue control or digital control is used, the spatial distribution of control signals provides a means for spatially distributing heat generation that is different from the physical distribution of the heat sources themselves. Such zoned or local control of heater FETs has the potential to enable the spatial distribution of heat generation to be flexibly and responsively controlled to an extent that is not possible through creative layout of the heater FET locations alone. Nevertheless, appropriate spatial distribution of the heater FETs in combination with appropriate spatial variation of the heater FET control voltages may be used together to generate a required thermal distribution.

### Modifications and Alternatives

As those skilled in the art will appreciate, a number of modifications and alternatives can be made to the above examples whilst still benefiting from the inventions embodied therein.

### Heat Spreaders

It will be appreciated, for example, that additional thermally conductive (e.g., metal) features may be placed in or on one or more layers of the integrated heater apparatus (e.g. upper layers and/or lower layers) that are configured for distributing/spreading heat more evenly between the discrete heat sources (tracks of the resistive element(s) and/or heater FET channels). Some of the heat spreader structures may be formed in the same layers used to form the resistive elements and/or the component parts of the FETs, such as the source, drain and/or gate electrodes. Thermally conductive (e.g., metal) vias may, for example, be formed between multiple layers of such heat spreading features, so as to increase the extent of heat spreading in a vertical direction (i.e., direction perpendicular to the heater surface).

The upper layer(s) of the heater apparatus integrated circuit may be formed from a thermally conductive, but electrically insulating, material, such as a ceramic-polymer silicone elastomer, or the like, which are more typically used for providing heat-sink coupling films.

The lateral dimensions and arrangements of any heat spreader(s) may allow for better local heat control in separate areas, by suitable placement of gaps and/or barriers between heat spreading features.

### Other Integrated Circuit Features

As described above, a particularly simple and hence low-cost (potentially flexible) integrated circuit heater apparatus based on the described examples may only include heating portions comprising one or more heater FETs (and possibly one or more resistive heater elements). It will be appreciated that inputs to these simple circuits may include supply voltage inputs (e.g., Vdd, V+, V−, ground and/or the like) and one or more control voltage inputs (e.g., a gate voltage Vg).

Nevertheless, more sophisticated heater apparatus integrated circuits may include some additional basic circuitry, for example associated with rectification of a supply voltage and/or electrostatic discharge (ESD) protection.

Moreover, further functionality associated with FET control voltage generation and distribution may also be included as part of the integrated circuit (as described in more detail below).

### Wireless Heaters

Whilst the integrated circuit heater apparatus may receive its electrical power from a battery or another source of DC power, it will be appreciated that some or all of the power supply requirements may be provided wirelessly. Such wireless power provision may contribute to a further reduction in the bill of materials (BoM) and enable very compact end products, optionally with thin and flexible form factors.

Examples of such wireless power provision include inductively-coupled wireless heaters. Inductive coupling is known in low frequency (LF) and high frequency (HF) radio-frequency identification (RFID) systems, for example, to transfer power and/or data between an RFID reader and an associated RFID tag. HF RFID systems typically operate with signal frequencies between 3 MHz and 30 MHz. Similar principles may be applied to implement a wireless heater apparatus in which inductively coupled energy from an antenna, similar to an RFID reader antenna, is used to power the driver FET heater current and/or control circuits. Specifically, the heater apparatus may be provided with an appropriate antenna (similar to that used for RFID systems) for receiving wireless signals, and appropriate energy harvesting/rectification circuitry for extracting energy from the wireless signals received by the antenna. The inductively-coupled power may, nevertheless, be supplemented by a battery, for example a thin, flexible battery.

Alternatively or additionally, wireless communication with the heater apparatus integrated circuit may allow some aspects of control to be performed remotely. For example, a control scheme for the heater apparatus (such as those described above), may be provided or adjusted by wireless communication between the integrated circuit and a reader.

In another example, alternatively or additionally, the amplitude of the RF field produced by a reader may be adjusted based on wireless communication between the integrated circuit heater apparatus and the reader. In this way, for example, the heater apparatus may request more or less RF power from the reader in order to set an appropriate temperature range.

In another example, alternatively or additionally, security may be provided through the use of one or more unique item identification codes that may, for example, be wirelessly exchanged between the heater apparatus and reader.

It will also be appreciated that the heater apparatus could be implemented as a radiatively-coupled wireless heaters, analogous to the inductively-coupled heater example described above, but operating at higher frequency (between 300 MHz and 3 GHz). This ultra-high frequency (UHF) approach may favour wireless communication over a wireless power supply, due to the larger transmitter-receiver separations and communication bandwidths enabled in the UHF range, and the relative difficulty of harvesting significant amounts of power.

Various other modifications will be apparent to those skilled in the art and will not be described in further detail here.

Clause 1. Heater apparatus comprising: a heating surface; and a plurality of heater devices arranged to provide heat for heating the heating surface; wherein the plurality of heater devices comprises at least one heater field effect transistor (FET) having a gate, a source, and a drain; and wherein the at least one heater FET is arranged to generate heat for heating the heating surface when a control signal is applied to the gate of the at least one heater FET, and a corresponding current flows between the drain and the source of the at least one heater FET.

Clause 2. Heater apparatus according to clause 1, wherein the at least one heater FET is a thin film transistor (TFT) fabricated from a thin semiconductor film.

Clause 3. Heater apparatus according to clause 1 or 2, wherein the at least one heater FET comprises a plurality of heater FETs, each heater FET of the plurality of heater FETs being arranged to generate heat for heating a different respective part of the heating surface.

Clause 4. Heater apparatus according to clause 3, wherein at least one heater FET of the plurality of heater FETs is connected in electronic series with at least one other heater FET of the plurality of heater FETs.

Clause 5. Heater apparatus according to clause 3 or 4, wherein the plurality of heater FETs comprise a first subset of heater FETs, and at least one further subset of heater FETs.

Clause 6. Heater apparatus according to clause 5, wherein the heater FETs of the first subset are connected in electronic series, the heater FETs of the at least one further subset are connected in electronic series, and the first subset of heater FETs is connected in electronic parallel with the at least one further subset of heater FETs.

Clause 7. Heater apparatus according to clause 5 or 6, wherein the heater FETs of the first subset are arranged beneath a first region of the heating surface that extends around, and defines an external boundary of, an inner area of the heating surface beneath which no heater FETs of the plurality of heater FETs are located, wherein the heater FETs of the at least one further subset are arranged beneath a second region of the heating surface that extends around the first region, and

Clause 8. Heater apparatus according to any of clauses 3 to 6, wherein the plurality of heater FETs are arranged in a regularly spaced array.

Clause 9. Heater apparatus according to any of clauses 3 to 8, wherein the plurality of heater FETs are provided on a common substrate.

Clause 10. Heater apparatus according to clause 9, wherein the common substrate is a flexible substrate.

Clause 11. Heater apparatus according to any of clauses 1 to 10, wherein the plurality of heater devices comprises at least one passive heater element for providing a required heating effect for heating the heating surface when a corresponding drive current flows through the at least one passive heater element.

Clause 12. Heater apparatus according to clause 11, wherein the at least one heater FET comprises at least one heater FET arranged to generate heat for heating a different part of the heating surface than a part of the heating surface heated by the at least one passive heater element.

Clause 13. Heater apparatus according to clause 11 or 12, wherein the at least one heater FET comprises at least one heater FET arranged to generate heat for heating part of the heating surface that the at least one passive heater element is also arranged to heat.

Clause 14. Heater apparatus according to any of clauses 11 to 13, wherein the at least one heater FET is arranged for providing the corresponding drive current for the at least one passive heater element.

Clause 15. Heater apparatus according to any of clauses 11 to 14, wherein the at least one passive heater element comprises at least one track having a resistance configured to provide the required heating effect when the corresponding drive current flows along the at least one conductive track.

Clause 16. Heater apparatus according to any of clauses 11 to 15, wherein the at least one passive heater element comprises at least one further FET, wherein the at least one further FET has an interconnected gate and drain and is configured to provide the required heating effect when the corresponding drive current flows between the drain and a source of the at least one further FET.

Clause 17. Heater apparatus according to any of clauses 11 to 16, wherein the at least one heater FET and the at least one passive heater element are provided as part of an integrated structure provided on a common substrate.

Clause 18. Heater apparatus according to clause 17, wherein the at least one heater FET is provided at a first distance from the common substrate in a direction orthogonal to the common substrate, and the at least one passive heater element is provided at a second distance from the common substrate in a direction orthogonal to the common substrate, wherein the first and second distances are different to one another.

Clause 19. Heater apparatus according to clause 17, wherein the at least one heater FET is provided at a first distance from the common substrate in a direction orthogonal to the common substrate, and the at least one passive heater element is provided at a second distance from the common substrate in a direction orthogonal to the common substrate, wherein the first distance equals the second distance.

Clause 20. Heater apparatus according to clause 18 or 19, wherein at least one of the first distance and the second distance is zero.

Clause 21. Heater apparatus according to any of clauses 17 to 20, wherein at least part of the at least one heater FET and at least part of the at least one passive heater element are provided in a common layer of the integrated structure.

Clause 22. Heater apparatus according to any of clauses 17 to 21, wherein at least part of the at least one heater FET is electrically connected to at least part of the at least one passive heater element by at least one conductive via provided as part of the integrated structure.

Clause 23. Heater apparatus according to any of clauses 1 to 22, further comprising at least one thermally conductive element arranged for spreading heat between at least a subset of the plurality of heater devices.

Clause 24. Heater apparatus according to any of clauses 1 to 23, further comprising control circuitry for providing control signals to the respective gate of each heater FET for controlling the current that flows between the drain and the source of that heater FET.

Clause 25. Heater apparatus according to clause 24, wherein the control circuitry is configured for providing digital control signals to the respective gate of each heater FET for controlling the current that flows between the drain and the source of that heater FET.

Clause 26. Heater apparatus according to clause 25, wherein the digital control signals comprise pulse width modulated signals having a duty cycle configured to control the power dissipated by the at least one heater FET.

Clause 27. Heater apparatus according to clause 24, wherein the control circuitry is configured for providing analogue control signals to the respective gate of each heater FET for controlling the current that flows between the drain and the source of that heater FET.

Clause 28. Heater apparatus according to any of clauses 1 to 27, further comprising at least one antenna for receiving wireless signals.

Clause 29. Heater apparatus according to clause 28, wherein the at least one antenna is configured for receiving wireless signals for controlling the at least one heater FET.

Clause 30. Heater apparatus according to clause 28 or 29, further comprising energy harvesting circuitry for harvesting energy from the wireless signals for powering the at least one heater device.

Clause 31. A method of manufacturing a heater apparatus according to any proceeding claim, the method comprising: fabricating the plurality of heater devices in an arrangement configured to provide heat for heating the heating surface; wherein the plurality of heater devices comprises the at least one heater field effect transistor (FET) having the gate, the source, and the drain; and wherein the at least one heater FET is arranged to generate the heat for heating the heating surface when the control signal is applied to the gate of the at least one heater FET, and the corresponding current flows between the drain and the source of the at least one heater FET.

Clause 32. A method of providing heating to an object, the method comprising: arranging heater apparatus according to any proceeding claim with the heater surface positioned to provide heat to the object; and applying a control signal to the gate of the at least one heater FET, to control the corresponding current flow between the drain and the source of the at least one heater FET, and so provide a required heating effect.

What is claimed is:

1. Heater apparatus comprising:
a heating surface; and
a plurality of heater devices arranged to provide heat for heating the heating surface;
wherein the plurality of heater devices comprises at least one heater field effect transistor (FET) having a gate, a source, and a drain; and
wherein the at least one heater FET is arranged to generate heat for heating the heating surface when a control signal is applied to the gate of the at least one heater FET, and a corresponding current flows between the drain and the source of the at least one heater FET.

2. Heater apparatus according to claim 1, wherein the at least one heater FET is a thin film transistor (TFT) fabricated from a thin semiconductor film.

3. Heater apparatus according to claim 1, wherein the at least one heater FET comprises a plurality of heater FETs, each heater FET of the plurality of heater FETs being arranged to generate heat for heating a different respective part of the heating surface.

4. Heater apparatus according to claim 3, wherein at least one heater FET of the plurality of heater FETs is connected in electronic series with at least one other heater FET of the plurality of heater FETs.

5. Heater apparatus according to claim 3, wherein the plurality of heater FETs comprise a first subset of heater FETs, and at least one further subset of heater FETs, wherein:
the heater FETs of the first subset are connected in electronic series,
the heater FETs of the at least one further subset are connected in electronic series; and
the first subset of heater FETs is connected in electronic parallel with the at least one further subset of heater FETs.

6. Heater apparatus according to claim 5, wherein the heater FETs of the first subset are arranged beneath a first region of the heating surface that extends around, and defines an external boundary of, an inner area of the heating surface beneath which no heater FETs of the plurality of heater FETs are located,
wherein the heater FETs of the at least one further subset are arranged beneath a second region of the heating surface that extends around the first region, and
wherein a width of the inner area is greater than a closest distance between the heater FETs of the first subset and the heater FETs of the at least one further subset.

7. Heater apparatus according to claim 3, wherein the plurality of heater FETs are arranged in a regularly spaced array.

8. Heater apparatus according to claim 3, wherein the plurality of heater FETs are provided on a common substrate, wherein the common substrate is a flexible substrate.

9. Heater apparatus according to claim 1, wherein:
the plurality of heater devices comprises at least one passive heater element for providing a heating effect for heating the heating surface when a corresponding drive current flows through the at least one passive heater element; and
the at least one heater FET is arranged to generate heat for heating a different part of the heating surface than a part of the heating surface heated by the at least one passive heater element.

10. Heater apparatus according to claim 9, wherein:
the at least one heater FET is arranged to generate heat for heating part of the heating surface that the at least one passive heater element is also arranged to heat, wherein:
the at least one heater FET is arranged for providing the corresponding drive current for the at least one passive heater element; and
the at least one passive heater element comprises at least one conductive track having a resistance configured to provide the heating effect when the corresponding drive current flows along the at least one conductive track.

11. Heater apparatus according to claim 10, wherein the at least one passive heater element comprises at least one further FET, wherein the at least one further FET has an interconnected gate and drain and is configured to provide the heating effect when the corresponding drive current flows between the drain and a source of the at least one further FET.

12. Heater apparatus according to claim 10, wherein the at least one heater FET and the at least one passive heater element are provided as part of an integrated structure provided on a common substrate, wherein:
the at least one heater FET is provided at a first distance from the common substrate in a direction orthogonal to the common substrate, and the at least one passive heater element is provided at a second distance from the common substrate in a direction orthogonal to the common substrate, wherein:
the first and second distances are different to one another; or
the first distance equals the second distance.

13. Heater apparatus according to claim 12, wherein at least one of the first distance and the second distance is zero.

14. Heater apparatus according to claim 12, wherein at least part of the at least one heater FET and at least part of the at least one passive heater element are provided in a common layer of the integrated structure.

15. Heater apparatus according to claim 12, wherein at least part of the at least one heater FET is electrically connected to at least part of the at least one passive heater element by at least one conductive via provided as part of the integrated structure.

16. Heater apparatus according to claim 1, further comprising at least one thermally conductive element arranged for spreading heat between at least a subset of the plurality of heater devices.

17. Heater apparatus according to claim 1, further comprising control circuitry for providing control signals to the respective gate of each heater FET for controlling the current that flows between the drain and the source of that heater FET, wherein:
the control circuitry is configured for providing digital control signals to the respective gate of each heater FET for controlling the current that flows between the drain and the source of that heater FET, wherein the digital control signals comprise pulse width modulated signals having a duty cycle configured to control the power dissipated by the at least one heater FET; or
the control circuitry is configured for providing analogue control signals to the respective gate of each heater FET for controlling the current that flows between the drain and the source of that heater FET.

18. Heater apparatus according to claim 1, further comprising:
at least one antenna for receiving wireless signals, wherein the at least one antenna is configured for receiving wireless signals for controlling the at least one heater FET; and
energy harvesting circuitry for harvesting energy from the wireless signals for powering the at least one heater device.

19. A method of manufacturing a heater apparatus, the heater apparatus comprising:
a heating surface; and
a plurality of heater devices arranged to provide heat for heating the heating surface;
wherein the plurality of heater devices comprises at least one heater field effect transistor (FET) having a gate, a source, and a drain; and
wherein the at least one heater FET is arranged to generate heat for heating the heating surface when a control signal is applied to the gate of the at least one heater FET, and a corresponding current flows between the drain and the source of the at least one heater FET,
the method comprising:
fabricating the plurality of heater devices in an arrangement configured to provide heat for heating the heating surface;
wherein the plurality of heater devices comprises the at least one heater field effect transistor (FET) having the gate, the source, and the drain; and
wherein the at least one heater FET is arranged to generate the heat for heating the heating surface when the control signal is applied to the gate of the at least one heater FET, and the corresponding current flows between the drain and the source of the at least one heater FET.

20. A method of providing heating to an object, the method comprising:
providing a heater apparatus comprising:
a heating surface; and
a plurality of heater devices arranged to provide heat for heating the heating surface;
wherein the plurality of heater devices comprises at least one heater field effect transistor (FET) having a gate, a source, and a drain; and
wherein the at least one heater FET is arranged to generate heat for heating the heating surface when a control signal is applied to the gate of the at least one heater FET, and a corresponding current flows between the drain and the source of the at least one heater FET; and
wherein the heating surface positioned to provide heat to the object; and
applying a control signal to the gate of the at least one heater FET, to control the corresponding current flow between the drain and the source of the at least one heater FET, and so provide a heating effect.
